(19) United States
(12) Patent Application Publication
(10) Pub. No.: US 2026/0301457 A1
(43) Pub. Date: Oct. 1, 2026

(54) INTERACTION METHOD BASED ON FIGURE RECOGNITION, AND DISPLAY DEVICE

(71) Applicant: BOE Technology Group Co., Ltd., Beijing (CN)

(72) Inventors: Zhanfu AN, Beijing (CN); Tingting WANG, Beijing (CN); Guangwei HUANG, Beijing (CN); Rui ZHENG, Beijing (CN); Lifei ZHAO, Beijing (CN); Huiguang MA, Beijing (CN); Lijuan QIAO, Beijing (CN); Zilong DU, Beijing (CN); Xin LIU, Beijing (CN); Tieli CHEN, Beijing (CN)

(21) Appl. No.: 18/996,602

(22) PCT Filed: Jul. 5, 2023
(86) PCT No.: PCT/CN2023/105899

§ 371 Date: Jan. 17, 2025

(30) Foreign Application Priority Data
Jul. 29, 2022 (WO) PCT/CN2022/109143
Apr. 27, 2023 (CN) 202310473009.3

(51) Int. Cl. G06V 30/32; G06F 3/04883

(52) U.S. Cl. CPC G06V 30/387; G06F 3/04883

(57) ABSTRACT

Provided in the present disclosure are an interaction method based on figure recognition, and a display device. The method comprises: receiving trajectory information of a plurality of figures drawn by a user, each figure comprising first trajectory information; performing figure recognition on the first trajectory information of each figure to obtain a recognition result of each figure, and adding the recognition result of each figure into a global recognition result list; and if the recognition result in the global recognition result list is matched with a preset rule in a preset rule set, clearing the global recognition result list, and executing an association operation according to an interactive instruction corresponding to the global recognition result list.

### CROSS-REFERENCE TO RELATED APPLICATIONS

The present disclosure is a national phase entry under 35 U.S.C § 371 of International Application No. PCT/CN2023/105899, filed on Jul. 5, 2023, which claims the priorities of the Chinese patent application No. PCT/CN2022/109143 filed to the China National Intellectual Property Administration on Jul. 29, 2022 and entitled “Method and display device for figure and text interaction”, and the Chinese patent application No. 202310473009.3 filed to the China National Intellectual Property Administration on Apr. 27, 2023 and entitled “Interaction method based on figure recognition, and display device”, the entire contents of which are incorporated by reference in the present disclosure.

### TECHNICAL FIELD

The present disclosure relates to the technical fields of human-computer interaction and computer vision processing, and in particular to interaction methods based on figure recognition and display devices.

### BACKGROUND

With the popularity of touch screens, there are more and more touch screen electronic products with more and more diverse functions. Currently, documents can be viewed through electronic devices and query sentences or words in the documents. However, when querying, it is needed to press and hold to select a text area, and then open a browser to copy the information you want to query. The operation is cumbersome and extremely inconvenient to use.

Currently, writing operations can also be performed on electronic devices with writing software installed. If a user needs to perform editing functions such as changing the brush color while writing, the user needs to click the brush type selection button in the “function selection area”. On the one hand, the function selection area occupies the display area of the display screen, which causes the writing area to be smaller. On the other hand, as the screen of the display device increases, the distance between the writing area and the function selection area increases. When the user wants to click something in the function selection area when writing in the writing area, it is inconvenient to operate when using this function.

### SUMMARY

The present disclosure provides interaction methods and display devices based on figure recognition. Based on user's hand-drawn figures, instructions corresponding to the figures are directly executed to perform corresponding operations, simplifying the user interaction operation process and improving user's interactive experience.

In a first aspect, an embodiment of the present disclosure provides an interaction method based on figure recognition, including:
receiving trajectory information of multiple figures hand-drawn by a user, where each figure comprises first trajectory information;
performing figure recognition on the first trajectory information of each figure to obtain a recognition result of each figure, and adding the recognition result of each figure to a global recognition result list; and
in response to the recognition result in the global recognition result list matching a preset rule in a preset rule set, emptying the global recognition result list and performing an association operation according to interactive instructions corresponding to the global recognition result list.

In a second aspect, an embodiment of the present disclosure provides an interaction method based on figure recognition, including:
receiving first trajectory information of a figure hand-drawn by a user; wherein the first trajectory information is configured to trigger execution of interactive instructions associated with first text information;
performing figure recognition on the first trajectory information and determining a figure recognition result; and
performing an association operation on the displayed first text information according to the interactive instructions corresponding to the figure recognition result.

In a third aspect, an embodiment of the present disclosure provides an interaction method based on figure recognition, including:
receiving multiple trajectory information hand-drawn by a user, where each stroke includes second trajectory information;
performing figure recognition on the second trajectory information of each stroke to obtain a recognition result of each stroke, and adding the recognition result of each stroke to a global recognition result list; wherein the first trajectory information is configured to trigger execution of interactive instructions associated with associated text information; and
in response to the recognition result in the global recognition result list matching any type of preset rule in a preset rule set, emptying the global recognition result list and performing an association operation according to the interactive instructions corresponding to the global recognition result list.

In a fourth aspect, an embodiment of the present disclosure provides an interaction method based on figure recognition, including:
receiving trajectory information of a figure drawn by a user;
performing figure recognition on the trajectory information to obtain a recognition result corresponding to the figure; and
invoking a writing function according to interactive instructions corresponding to the recognition result, and displaying menu items of the writing function in a writing area.

In a fifth aspect, an embodiment of the present disclosure provides a display device, including a display and a controller;
the display is configured to display content; and
the controller is configured to perform steps of the method of the first aspect, the second aspect, the third aspect or the fourth aspect.

In a sixth aspect, an embodiment of the present disclosure provides a computer storage medium on which computer programs are stored, when the computer programs are executed by a processor, steps of the method according to the first aspect, the second aspect, the third aspect or the fourth aspect are implemented.

These aspects and other aspects of the present disclosure will be more clearly understood in the following description of the embodiments.

### BRIEF DESCRIPTION OF FIGURES

In order to more clearly illustrate the technical solutions in the embodiments of the present disclosure, a brief introduction will be given below to the drawings that need to be used in the description of the embodiments. Obviously, the drawings in the following description are only some embodiments of the present disclosure. Those of ordinary skill in the art can also obtain other drawings based on these drawings without exerting any creative effort.

FIG. 1 is a workbench software usage interface diagram of a smart all-in-one machine provided by an embodiment of the present disclosure.

FIG. 2 is a flow chart of an interaction method based on figure recognition provided by an embodiment of the present disclosure.

FIG. 3 is a schematic diagram of a user drawing a question mark provided by an embodiment of the present disclosure.

FIG. 4 is a schematic diagram of determining a writing area provided by an embodiment of the present disclosure.

FIG. 5 is a schematic diagram of a coordinate transformation relationship provided by an embodiment of the present disclosure.

FIG. 6 is a schematic diagram of a user drawing graphics at will provided by an embodiment of the present disclosure.

FIG. 7 is a drawing schematic diagram of querying the content of the area above the dashed line provided by an embodiment of the present disclosure.

FIG. 8 is an overall flow chart of interaction based on figure recognition provided by an embodiment of the present disclosure.

FIG. 9 is a flow chart of rationality judgment provided by an embodiment of the present disclosure.

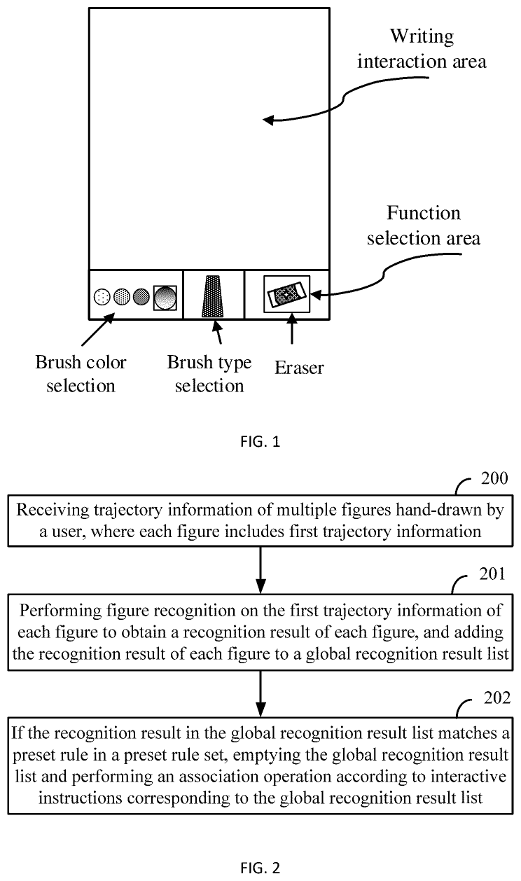

FIGS. 1A-10B are schematic diagrams of the normalization effect of a flat stroke provided by an embodiment of the present disclosure.

FIGS. 11A-11B are schematic diagrams of the normalization effect of a thin and tall stroke provided by an embodiment of the present disclosure.

FIG. 12 is a schematic diagram of trajectory information of sampled strokes provided by an embodiment of the present disclosure.

FIGS. 13A-13B are schematic comparison diagrams before and after data resampling provided by an embodiment of the present disclosure.

FIG. 14 is an implementation flow chart of data resampling provided by an embodiment of the present disclosure.

FIG. 15 is an implementation flow chart of data post-processing provided by an embodiment of the present disclosure.

FIG. 16 is a schematic structural diagram of a model based on figure recognition provided by an embodiment of the present disclosure.

FIG. 17 is an implementation flow chart of an interaction method based on figure recognition provided by an embodiment of the present disclosure.

FIG. 18 is an example diagram of a hand-drawn figure provided by an embodiment of the present disclosure.

FIGS. 19A-19C are schematic diagrams of invoking a writing function provided by an embodiment of the present disclosure.

FIG. 20 is an implementation flow chart of an interaction method based on figure recognition provided by an embodiment of the present disclosure.

FIG. 21 is a schematic structural diagram of a model based on figure recognition provided by an embodiment of the present disclosure.

FIG. 22 is a schematic diagram of figure recognition of input strokes provided by an embodiment of the present disclosure.

FIG. 23 is a schematic diagram of a multi-stroke interaction process provided by an embodiment of the present disclosure.

FIGS. 24A-24B are a display interface diagram for automatically generating meeting minutes provided by an embodiment of the present disclosure.

FIG. 25 is a display interface diagram for inserting pictures provided by an embodiment of the present disclosure.

FIGS. 26A-26D are a display interface diagram for generating meeting minutes provided by an embodiment of the present disclosure.

FIG. 27 is a display interface diagram of text alignment provided by an embodiment of the present disclosure.

FIGS. 28A-28B are display interface diagrams for automatically converting text provided by an embodiment of the present disclosure.

FIGS. 29A-29B are display interface diagrams for automatically generating to-do items provided by an embodiment of the present disclosure.

FIGS. 30A-30B are schematic scene diagrams of a smart calendar provided by an embodiment of the present disclosure.

FIGS. 31A-31B are schematic diagrams of adding to-do items provided by an embodiment of the present disclosure.

FIG. 32 is a schematic diagram of prompting to-do items provided by an embodiment of the present disclosure.

FIG. 33 is an implementation flow chart of an interaction method based on figure recognition provided by an embodiment of the present disclosure.

FIG. 34 is a schematic diagram of a display device provided by an embodiment of the present disclosure.

FIG. 35 is a schematic diagram of a display device provided by an embodiment of the present disclosure.

FIG. 36 is a schematic diagram of a display device provided by an embodiment of the present disclosure.

FIG. 37 is a schematic diagram of a display device provided by an embodiment of the present disclosure.

### DETAILED DESCRIPTION

In order to make the purpose, technical solutions and advantages of the present disclosure clearer, the present disclosure will be described in further detail below in conjunction with the accompanying drawings. Obviously, the described embodiments are only some, not all, of the embodiments of the present disclosure. Based on the embodiments in the present disclosure, all other embodiments obtained by those of ordinary skill in the art without creative efforts fall within the protection scope of the present disclosure.

In the embodiments of the present disclosure, the term “and/or” describes association relationships of associated objects, indicating that there can be three relationships, for example, A and/or B, which can represent: A exists alone, A and B exist simultaneously, and B exists alone. The character “/” generally indicates that the associated objects are in an “or” relationship.

The application scenarios described in the embodiments of the present disclosure are to more clearly illustrate the technical solutions of the embodiments of the present disclosure, and do not constitute a limitation on the technical solutions provided by the embodiments of the present disclosure. Those of ordinary skill in the art will know that with the emergence of new application scenarios, the technical solutions provided by the embodiments of the present disclosure are equally applicable to similar technical problems. In the description of the present disclosure, unless otherwise specified, “plurality of” means two or more.

Embodiment 1. With the popularity of touch screens, there are more and more touch screen electronic products. It has become a common habit to use electronic devices to view documents, such as reading e-books and checking news. Currently, when using electronic devices to view documents or e-books, it is supported to take notes on the screen, such as comments, highlighting, etc. However, when you need to query some words or sentences in an electronic document, the general approach is to press the screen to select the text area to copy, then open the browser and paste the copied text into the browser search window for query. This method of operation is extremely inconvenient for users because the browser needs to be opened once during the process.

The current workbench software interface of the smart all-in-one machine is shown in FIG. 1. Users can perform writing operations in the writing area, such as handwriting input, mathematical operations, chart analysis and other tasks. However, when the user wants to change the color of stoke shape while writing in the writing area, the user needs to click the brush color selection button in the “Function selection area”, and an RGB palette will pop up for the user to choose; when the user wants to change the stoke shape, the user needs to click the brush type selection button in the “Function selection area”; when the user wants to clear the writing area or erase some content, the user needs to click the eraser button in the “Function selection area” to select different erasure types. This method of clicking to select functions has two disadvantages: (1) the function selection area occupies a certain area of the entire display screen, reducing the use area of the writing area; (2) as the screen of the all-in-one machine increases, the distance between the writing area and the function selection area will increase, so when writing in the writing area, it is very troublesome and inconvenient to click on a function in the function selection area.

It should be noted that the display device in the embodiments refers to a large-size (generally more than 50 inches) intelligent interactive display device with touch handwriting function. On this display device, writing programs such as an electronic whiteboard are installed, and users can use finger, active pen or passive pen to write on the display device. The display device may include display modules such as liquid crystal display (LCD), organic electroluminescence display (OLED), and electronic ink, and can display handwriting in real time.

The embodiments provide an interaction method and display device based on figure recognition, which determines one or more figures drawn by the user by performing figure recognition on trajectory information of each figure drawn by the user, and provides a global recognition result list to determine interactive instructions corresponding to one or more figures. When a recognition result of each recognized figure matches a preset rule(s), association operations corresponding to the interactive instructions are performed. When applied to document browsing and e-book browsing scenarios, it is convenient for users to directly call the query function by drawing figures on the document. It does not require the user to open the browser once, making the interaction method more convenient. When applied to writing software scenarios, it is convenient for users to directly call writing-related functions by drawing figures in the writing area, eliminating the need for users to click function buttons to perform association operations, reducing the interaction process and making the interaction method more efficient and convenient.

As shown in FIG. 2, embodiments of the present disclosure provide an interaction method based on figure recognition. The specific implementation process of the method is as follows.

Step 200: Receiving trajectory information of multiple figures hand-drawn by a user, where each figure includes first trajectory information.

Optionally, the figure in the embodiments of the present disclosure may be a figure containing one stroke, or a figure containing multiple strokes.

Step 201: Performing figure recognition on the first trajectory information of each figure, to obtain a recognition result of each figure, and adding the recognition result of each figure to a global recognition result list.

In the implementation, every time first trajectory information drawn by the user is received, figure recognition is performed on the first trajectory information to obtain the recognition result of one stroke, and the recognition result of one stroke is added to the global recognition result list.

Step 202: If the recognition result(s) in the global recognition result list match a preset rule(s) in a preset rule set, emptying the global recognition result list and performing an association operation according to the interactive instructions corresponding to the global recognition result list.

In the implementations, an association operation is performed according to the interactive instructions corresponding to the global recognition result list, specifically including any of the following:
(1) Performing an association operation(s) according to interactive instructions corresponding to a recognition result(s) of a figure(s) stored in the global recognition result list;
(2) Performing an association operation(s) according to interactive instructions corresponding to a preset rule(s) matched by a recognition result(s) of a figure(s) stored in the global recognition result list.

Optionally, the preset rule set in the embodiments includes one preset rule or multiple preset rules.

In some embodiments, the preset rule includes a plurality of figure categories arranged in a preset order, and determining whether to add the recognition result to the global recognition result list through the following steps:
if the recognition result and recognition order of the current figure match the figure category and the arrangement order of the figure category in the preset rules respectively, then the recognition result of the current figure is added to the global recognition result list.

It should be noted that, in order to ensure that the recognition order of figures corresponds to the recognition order of figures corresponding to the figure categories in the global recognition result list, the number of the figure recognition in the embodiments can be reset when the global recognition result list is emptied, so as to ensure that the starting time of counting the number of recognitions is based on when the global recognition result list is empty.

In some embodiments, the preset rules include multiple figure categories arranged in a preset order. The recognition result of the current figure can also be added to the global recognition result list first, and then whether the recognition result and the recognition order in the global recognition result list match the figure categories and the figure categories order respectively in the preset rules, can be determined, specifically as follows:
adding the recognition result of the current figure to the global recognition result list to obtain the current global recognition result list;
if the recognition result in the current global recognition result list does not match the figure categories in the preset rules, emptying the global recognition result list; or,
if the recognition result in the current global recognition result list matches the figure categories in the preset rules, and an arrangement order of the recognition results in the current global recognition result list does not match an arrangement order of the figure categories, emptying the global recognition result list.

In implementations, the display device can actually obtain the trajectory information input on the screen, and every time first trajectory information is received, it will identify the first trajectory information. In one case, every time the first trajectory information is identified, it will determine whether the current recognition result and the recognition order match the figure categories and the figure categories order in the preset rules, and determine whether to add the recognition result to the global recognition result list based on the matching result. In another case, every time the first trajectory information is identified, the recognition result will be added to the global recognition result list, and whether the recognition result and the arrangement order of the recognition result in the global recognition result list match the preset rules is determined.

In some embodiments, after adding the recognition result of each figure to the global recognition results list, the embodiments further perform the following step:
when the length of the global recognition result list reaches a threshold, determining whether the recognition result(s) in the global recognition result list match(es) the preset rule(s) in the preset rule set.

Optionally, if the length of the global recognition result list reaches a threshold and the recognition results and recognition order in the global recognition result list completely match the preset rules, then the global recognition result list is emptied and association operations are performed according to the interactive instructions corresponding to the global recognition result list.

The length of the global recognition result list is determined based on the number of recognition results in the global recognition result list. Optionally, in this embodiment, the length of the global recognition result list is 1 or an integer greater than 1. When the length of the global recognition result list is 1, the user only needs to input a figure of one stroke, and the figure corresponds to interactive instructions, then association operations corresponding to the interactive instructions are performed directly. When the length of the global recognition result list is 2 or an integer greater than 2, the user needs to input multiple figures or multiple strokes, and only when the user completes all inputs, association operations are performed according to corresponding interactive instructions.

During implementations, the embodiment can identify a figure formed by one stroke and directly perform corresponding association operations, and can also identify a figure of multiple strokes and perform corresponding association operations. By invoking the function selection of the display device through figure recognition in this embodiment, the existing function selection button can be hidden. When a function needs to be used, a specific figure is drawn at any position on the screen, and the system can directly invoke the corresponding function for users to choose or use.

During implementation, the display device can obtain the trajectory information input on the screen in real time. Each time it receives the trajectory information of a stroke, it identifies the trajectory information of the stroke, and determines whether the recognition result and recognition order match the preset rules; if yes, the recognition result is added to the global recognition result list and whether the length of the global recognition result list reaches the threshold is determined. If it reaches the threshold, the corresponding function selection interface is invoked according to the preset rules corresponding to the global recognition result list. For example, in the writing software scenario, the user inputs one stroke or multiple strokes to invoke the writing function, and a function selection item pops up at the current writing position in the writing interaction area, and the user can select the desired function based on the pop-up function selection item. When a user uses a touch screen electronic product or display device to view e-books or electronic documents and encounters information that should be queried, the user can draw an arbitrary-shaped line under the text that needs to be queried while using the touch screen to take notes, and then draw a question mark. The display device will perform figure recognition on the trajectory information of the received stroke. When it recognizes that the figure drawn by the user is an underline+question mark, it will directly invoke the query function to circle (e.g., highlighting) the content of the user's current line drawing area, and automatically perform query/translation functions. This query method is completely consistent with the method of querying content when reading paper books in daily life, which greatly improves the interactivity of users when using touch electronic products.

In some embodiments, the preset rules include figure categories arranged in a preset order. The embodiment empties the global recognition result list based on any of the following situations.

(1) If the recognition result of the current figure does not match the figure categories in the preset rules, the global recognition result list will be emptied.

(2) If the recognition result of the current figure matches the figure categories in the preset rules and the recognition order of the recognition result does not match the arrangement order of the figure categories in the preset rules, the global recognition result list will be emptied.

In implementations, every time the trajectory information of a stroke drawn by the user is received, figure recognition is performed on the trajectory information of the stroke to obtain the recognition result of the stroke, and the recognition result of the stroke is added to the global recognition result list. At this time, whether the length of the global recognition result list reaches the threshold and whether the recognition results in the global recognition result list completely match the preset rules are determined. If the length of the global recognition result list reaches the threshold and the recognition results in the global recognition result list completely match the preset rules, then the global recognition result list is emptied and the association operation is performed according to the interactive instructions corresponding to the global recognition result list. If the length of the global recognition result list does not reach the threshold and all recognition results in the global recognition result list partially match the preset rules, recognition is continued to be performed on the trajectory information of the received strokes, and the recognition results are added to the global recognition result list. If the recognition result of any stroke in the global recognition result list does not match the preset rules, the global recognition result list will be emptied.

In some embodiments, when the recognition result obtained by performing figure recognition on the trajectory information of the current stroke drawn by the user is a stroke in a preset multi-stroke figure, it is necessary to combine the first trajectory information contained in the multi-stroke figure, and recognize the combined trajectory information. In the implementations, N strokes received after the current stroke are determined according to the number N of strokes of the preset multi-stroke figure, N is an integer greater than or equal to 1. The current stroke and the N strokes received after the current stroke are combined to obtain the combined trajectory information. The figure recognition is performed on the combined trajectory information to obtain the recognition results corresponding to the multi-stroke figures drawn by the user, and the recognition results corresponding to the multi-stroke figure are added to the global recognition result list.

Optionally, taking the figure including a first figure and the first figure including a continuous first stroke and second stroke as an example, the recognition is further performed by the following steps:
receiving trajectory information of the first stroke, recognizing the trajectory information of the first stroke, and if the recognition result matches a first stroke category, adding the recognition result of the first stroke to the global recognition result list; and
receiving trajectory information of the second stroke, combining the trajectory information of the first stroke and the trajectory information of the second stroke, performing figure recognition on the combined trajectory information, and adding the recognition result of the combined trajectory information to the global recognition result list.

In implementations, taking a “question mark” drawn by the user as an example, a question mark-like stroke (a question mark without a dot) is drawn first, and then a dot is drawn below the question mark-like stroke, then the question mark-like stroke+dot will be used as a question mark figure. When the user draws a question mark-like stroke first, it determines that one more stroke still needs to be received, it can wait to receive the one more stroke and recognize the one more stroke and the previous stroke as one figure.

Optionally, N strokes received after the current stroke are determined in the following way:
1a) determining the writing area of the N strokes according to the trend of the current stroke; where, the trend represents the trend direction at the end of the current stroke;
1b) if the N strokes are received in the writing area, determining the N strokes in the writing area as N strokes received after the current stroke.

Optionally, taking the figure including a first figure including a continuous first stroke and second stroke as an example, the embodiment further performs the following steps after receiving the trajectory information of the first stroke.

Step 1) Determining the writing area of the trajectory information of the second stroke according to the trajectory information of the first stroke.

Optionally, the writing area of the trajectory information of the second stroke is determined based on the trajectory information of the first stroke in the following manner:
determining a center point of the writing area according to a center or a center of gravity of the trajectory information of the first stroke and a last trajectory point of the trajectory information of the first stroke; and
determining the writing area of the trajectory information of the second stroke according to the center point of the writing area.

Step 2) When the trajectory information of the second stroke is located in the writing area, combining the trajectory information of the first stroke and the trajectory information of the second stroke, and performing figure recognition on the combined trajectory information.

Step 3) When the trajectory information of the second stroke is not within the writing area, emptying the global recognition result list.

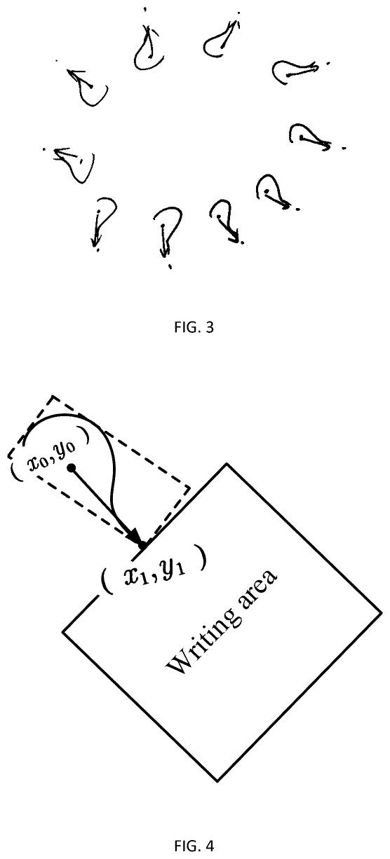

As shown in FIG. 3, the embodiment provides a schematic diagram of drawing a question mark by the user. The user can draw the question mark at any position on the display screen and in any direction. Under normal circumstances, the most reasonable position for the second stroke of the question mark to appear is follow the trend at the end of the first stroke (as shown by the arrow in the picture). This direction is defined as the correct trend of the question mark. Therefore, the writing area of the next stroke can be determined based on the trend of the current stroke.

Optionally, determining the trend and writing area through the following methods:
determining the trend of the current stroke based on the center or the center of gravity of the current stroke and the last trajectory point of the current stroke;
determining the center point of the writing area based on the trend of the current stroke;
determining the size of the writing area according to the size of the minimum enclosing rectangle of the current stroke; and
determining the position of the writing area based on the center point of the writing area and the size of the writing area.

In implementations, the user drawing a question mark is taken as an example. Generally, the second stroke of the question mark drawn by the user is in the same direction as the first stroke of the question mark. If the second stroke appears above the first stroke, it means that the second stroke and the currently received trajectory information do not represent a normal question mark, and they may be suitable for a certain kind of writing coincidence, such as the operation where the user really wants to write −72. Since the number 7 is very similar to the first stroke of the question mark, at this time, in order to avoid misunderstanding the number 2 and 7 as question marks, in this embodiment, when the current stroke is recognized as a question mark-like stroke, the “trend” of the question mark-like strode is calculated based on the question mark-like trajectory points, and the rational writing area of the second stroke of the question mark is determined through the “trend”. After calculating the writing area, it is determined whether the trajectory points of the next received stroke fall within the currently calculated writing area. If the next received stroke is not within the writing area, it means that the user does not want to draw a question mark, so by defining the writing area to determine whether the next stroke falls within the writing area, the accuracy of figure recognition can be effectively improved.

As shown in FIG. 4, the embodiment provides a schematic diagram for determining the writing area. Taking the user drawing a question mark with two strokes as an example, when the user first draws a question mark-like stroke, the user determines the writing area for the next stroke through the following steps.

Step 400: Determining the center or center of gravity of the question mark-like stroke.

In the implementation, the center of gravity of the question mark-like stroke is determined through the following formula:

$$X = mean ( data [ 1 : len ( data ) - 10 ] ) ; \qquad Formula ( 1 )$$

X(x₀, y₀) represents the center of gravity, len(data) represents the data volume of trajectory points of the stroke currently received. When the center of gravity is calculated by Formula (1), the last ten trajectory points of the trajectory information of the question mark-like stroke are removed, so as to improve the accuracy of calculation.

Step 401: Determining the trend of the question mark-like stroke based on the center of gravity of the question mark-like stroke and the last trajectory point of the question mark-like stroke.

During implementations, the trend of the question mark-like stroke is determined through the following formula:

$$k = \frac{{y}_{1} - {y}_{0}}{{x}_{1} - {x}_{0}} , θ = arc tan ( - \frac{1}{k} ) ; \qquad Formula ( 2 )$$

(x₀, y₀) represents the center of gravity, (x₁, y₁)=data[−1], which represents the last trajectory point in the trajectory information of the question mark-like stroke, k and θ represent the trend of the current stroke, i.e., the trend of the question mark-like stroke.

Step 402: Determining the size of the writing area based on the size of the minimum enclosing rectangle of the question mark-like stroke.

In implementations, the maximum value of the width and height of the minimum enclosing rectangle of the question mark-like stroke is determined.

The maximum value is multiplied by 1.5 to obtain the side length max of the writing area, the writing area can be set to a square. Optionally, the embodiment does not place too many restrictions on the shape of the writing area, and can customize the shape of the writing area according to the shape of the multi-stroke figure. If the shape of the writing area is not a square, such as a rectangle, the width and height of the writing area can be determined based on the width and height of the minimum enclosing rectangle of the first stroke. The embodiment does not limit this too much.

Step 403: Determining the position of the writing area based on the trend of the question mark-like stroke and the size of the writing area.

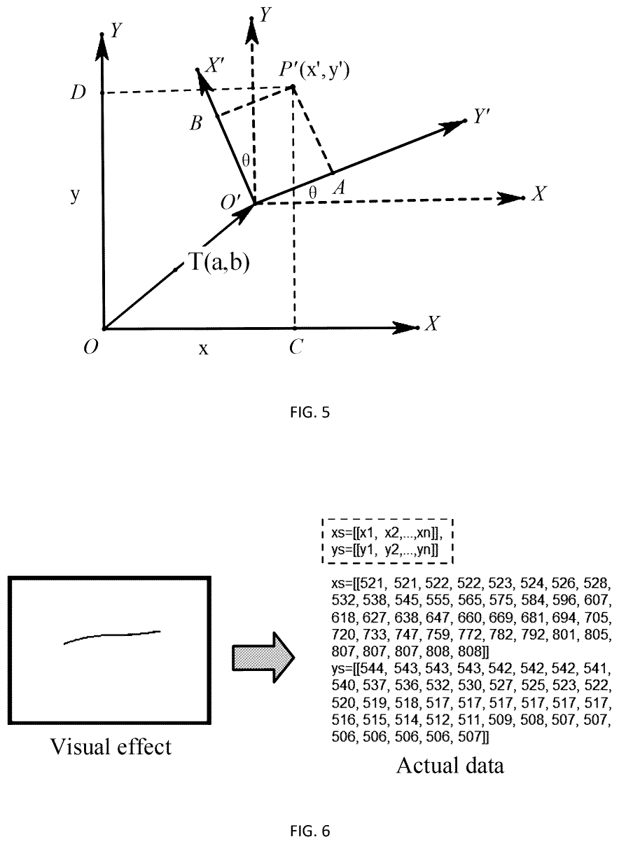

In implementations, the last trajectory point of the question mark-like stroke is located at the midpoint of an edge of the writing area, and the trend k of the question mark-like stroke is perpendicular to the edge. The coordinates of four vertices of the writing area are calculated based on θ and the side length max of the writing area. The coordinates of the four vertices of the writing area in the coordinate system of the writing area can be calculated according to the coordinate system of the writing area first, and then the coordinates of the four vertices are converted to the coordinate system of the display screen, to obtain the final position of the writing area on the display screen. The schematic diagram of the coordinate conversion relationship is shown in FIG. 5. The coordinate system X′O′Y′ is the coordinate system of the writing area, and the coordinate system XOY is the coordinate system of the display screen. The four vertices are calculated based on θ and side length of the writing area, such as P′(x′, y′), first calculating the coordinates (2×max, 2×max) of P′(x′, y′) in the coordinate system X′O′Y′, then converting the (2×max, 2×max) to the coordinate system XOY to obtain the corresponding coordinates of P′(x′, y′) in the coordinate system XOY. The conversion relationship is as follows:

$$new\_x = {x}^{′} cos θ + {y}^{′} sin θ + a ; = new\_y = - {x}^{′} sin θ + {y}^{′} cos θ + b ; \qquad Formula ( 3 )$$

(new_x, new_y) are the vertex coordinates of the writing area under the coordinate system XOY after conversion, and (x′, y′) are the vertex coordinates of the writing area under the coordinate system X′O′Y′.

In the implementation, Formula (3) is the result of the rotation+translation operation. After the coordinate system is rotated, it needs to be translated. The first step is to rotate the P′ point from the coordinate system X′O′Y′ to the coordinate system XO′Y. θ is a parameter required for rotation. The second step is to translate the coordinates under XO′Y to the coordinate system XOY, where a and b represent the parameters required for translation in the X and Y directions respectively.

After determining the position of the writing area of the first stroke in the multi-stroke figure through the above method, it can be determined whether the starting point, center point and last trajectory point of the received second stroke fall in the writing area. If so, it means that the second stroke received is the second stroke in the multi-stroke figure, otherwise the first stroke in the multi-stroke figure stored in the global recognition result list is emptied.

In some embodiments, if it is determined that the global recognition result list is empty and the data volume of the first trajectory information of each figure is greater than the trajectory point threshold, the figure recognition is performed on the first trajectory information of each figure.

Optionally, the data volume in the embodiments includes the number of trajectory points in the first trajectory information.

During implementation, in order to prevent the trajectory information generated due to the user's accidental touch from being misrecognized and consuming computing resources of the display device, in this embodiment, after receiving the trajectory information of the strokes, the trajectory information can be reasonably pre-judged before performing figure recognition. For example, every time the trajectory information of a stroke drawn by the user is received, it is judged whether the current global recognition result list is empty. If it is empty, it is judged whether the data volume of the trajectory information of the stroke is greater than the trajectory point threshold. For example, whether it is greater than 3, that is, whether the number of trajectory points of the stroke is greater than 3. If it is greater than 3, the figure recognition is performed on the stroke. Otherwise, the trajectory information is considered to be generated by the user's accidental touch, and the trajectory information is emptied.

In some embodiments, the reasonable judgment on the received trajectory information of each stroke is performed through the following steps:
Step 11, each time trajectory information of a stroke drawn by the user is received, determining whether the current global recognition result list is empty, if it is empty, proceeding to step 12, otherwise proceeding to step 14;
Step 12, determining whether the data volume of the trajectory information of the stroke currently received is greater than the trajectory point threshold, if yes, proceeding to step 13, otherwise no response will be made;
Step 13, performing figure recognition on the trajectory information of the stroke;
Step 14, determining whether the length of the global recognition result list reaches the threshold and whether the recognition results in the global recognition result list completely match the preset rules, if yes, proceeding to step 15; otherwise, proceeding to step 16 or step 19;
Step 15, clearing the global recognition result list and performing corresponding association operations;
Step 16, if the length of the global recognition result list does not reach the threshold and all recognition results in the global recognition result list partially match the preset rules, continuing to recognize the trajectory information of the received strokes and adding the recognition results to the global recognition results list;
Step 17, determining whether the recognition result obtained by figure recognition using the trajectory information of the current stroke is a stroke in the preset multi-stroke figure, if yes, proceeding to step 18; otherwise, proceeding to step 11;
Step 18, combining the current stroke and the N strokes received after the current stroke to obtain the combined trajectory information, performing figure recognition on the combined trajectory information, and adding the recognition results to the global recognition result list;
Step 19, if the length of the global recognition result list does not reach the threshold and any recognition result in the global recognition result list does not match the preset rules, emptying the global recognition result list.

In the implementation, underline+question mark-like stroke+question mark are used as the preset rules. The interactive instructions corresponding the preset rules are to query the content of the area above the underline. The underline includes lines of any shape, such as straight lines, wavy lines, and curves. etc., and can support underlines within ±45°. The question mark (?) includes any question mark within an angle of 360°. Since the question mark is composed of two strokes, in this embodiment, in order to better recognize the question mark, the question mark is recognized twice. The first stroke of the question mark is recognized for the first time, and the first stroke of the question mark is named as a question mark-like stroke. If the recognition result of the first stroke is the question mark-like stroke, the second stroke and the first stroke are combined into one stroke figure to be recognized to determine whether the recognition result is a real question mark. When the user draws figures of other shapes, such as characters, Chinese characters, numbers, graffiti, etc., there will be no query response for such trajectory information.

Optionally, when the user wants to use the query function, the correct operation sequence can be underline+question mark-like stroke+question mark. Therefore, the present disclosure sets a global recognition result list result_list to store recognition results. For example, the recognition results can be divided into 5 categories, 0 represents a space, 1 represents a underline, 2 represents a question mark, 3 represents a question mark-like stroke, and 4 represents the others. When the global recognition result list is empty, and the recognition result of the first stroke received for the first time is 1 (representing a underline), and the recognition result of the second stroke received for the second time is 3 (representing a question mark-like stroke), the recognition result of the third stroke is 2 (representing a question mark) (the content of the global recognition result list is result_list=[1, 3, 2]), it means that the user wants to use the underline+question mark function, and the system can highlight contents in the user underlined area, and then the global recognition result list is emptied. Here, the third stroke is a new stroke obtained by combining the stroke received for the third time and the second stroke received for the second time. All other combinations of recognition results are considered not to be the user's intended use of the underline+question mark function (it may be the user accidentally touching or taking notes, etc.), and no results will be returned. In this case, the contents of the global recognition result list are such as result_list=[4], result_list=[3], result_list=[1, 3, 4].

The first trajectory information in this embodiment refers to a series of discrete two-dimensional coordinate points obtained after sampling the stroke.

As shown in FIG. 6, this embodiment provides a schematic diagram in which the user draws figures at will. When the user draws a line on the display screen, the display device samples the content drawn by the user to obtain a corresponding series of two-dimensional coordinate points, that is, the trajectory information corresponding to the line drawn by the user is a discrete sampling point. If the user's brush still stays on the screen after the drawing is completed, trajectory points will continue to be collected at the stay position, resulting in multiple identical trajectory points being collected. Therefore, in order to remove redundant trajectory points and collected noise, the first trajectory information can further be preprocessed before the figure recognition.

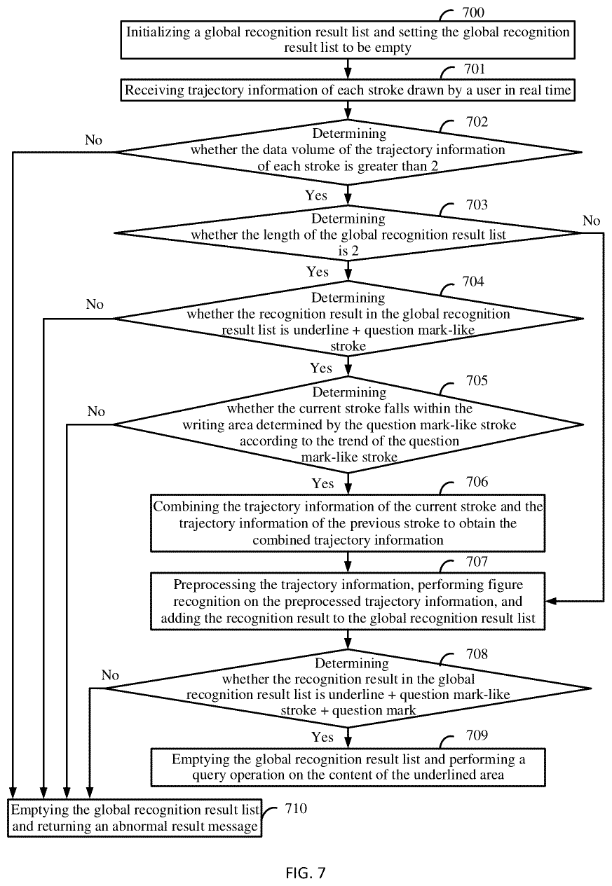

In the implementation, for example, the underline+question mark-like stroke+question mark are used as the preset rules, and the interactive instructions corresponding to the preset rules are to query the content of the area above the underline. As shown in FIG. 7, the embodiment determines the rationality of the trajectory information of strokes drawn by the user as follows.

Step 700: initializing the global recognition result list and setting the global recognition result list to be empty.

Step 701: receiving the trajectory information of each stroke drawn by the user in real time.

In the implementation, it is possible to determine which trajectory information is the trajectory information of the same stroke by pressing, moving, and lifting included in a trigger event.

Step 702: determining whether the data volume of the trajectory information of each stroke is greater than 2, if yes, proceeding to step 703; otherwise, proceeding to step 710.

In the implementation, if the current global recognition result list is empty and the number of trajectory points obtained at this time is less than 2, it is considered that the user most likely does not want to invoke this function at this time, and the coordinates of the currently obtained trajectory points are directly emptied. If the number of trajectory points obtained at this time is greater than 2, it is considered that the user may invoke this function.

Step 703: determining whether the length of the global recognition result list is 2, if so, proceeding to step 704; otherwise, proceeding to step 707.

The length of the global recognition result list refers to the number of recognition results included in the global recognition result list.

Step 704: determining whether the recognition result in the global recognition result list is an underline+question mark-like stroke, if so, proceeding to step 705; otherwise, proceeding to step 710.

Step 705: determining whether the current stroke falls within the writing area determined by the question mark-like stroke according to the trend of the question mark-like stroke, if so, proceeding to step 706; otherwise, proceeding to step 710.

Step 706: combining the trajectory information of the current stroke and the trajectory information of the previous stroke to obtain the combined trajectory information.

Step 707: preprocessing the trajectory information, performing figure recognition on the preprocessed trajectory information, and adding the recognition results to the global recognition result list.

Step 708: determining whether the recognition result in the global recognition result list is underline+question mark-like stroke+question mark, if yes, proceeding to step 709; otherwise, proceeding to step 710.

Step 709: emptying the global recognition result list and performing a query operation on the content of the underlined area.

Step 710: emptying the global recognition result list and returning an abnormal result message.

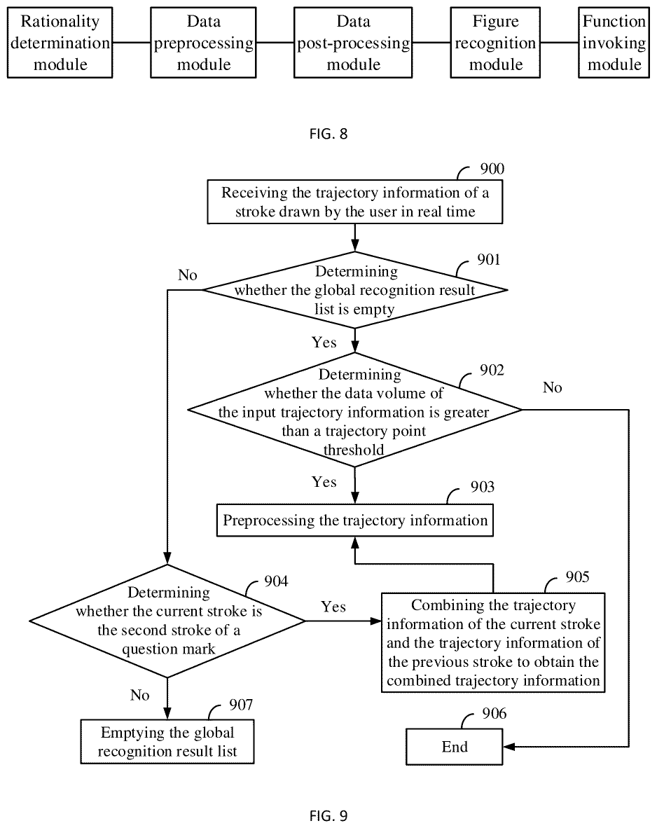

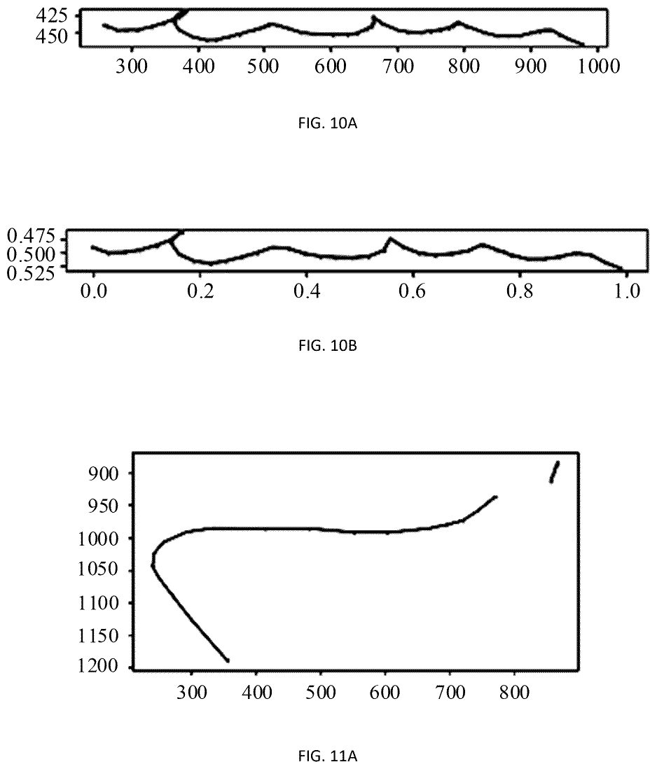

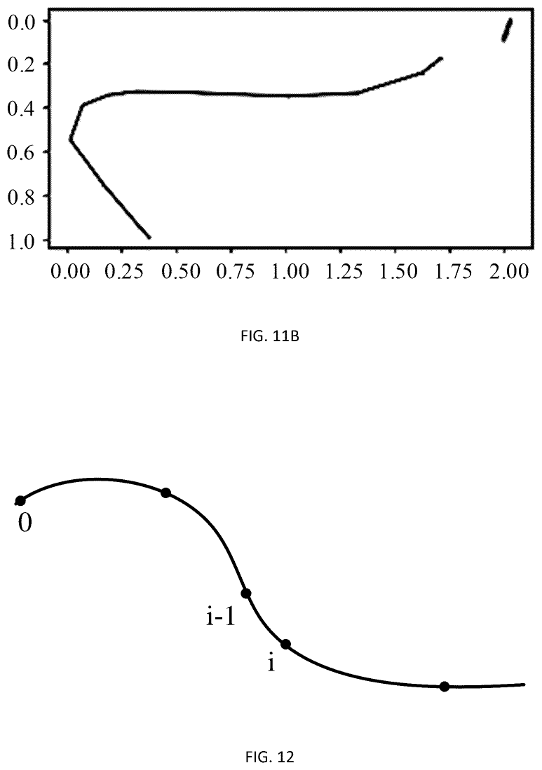

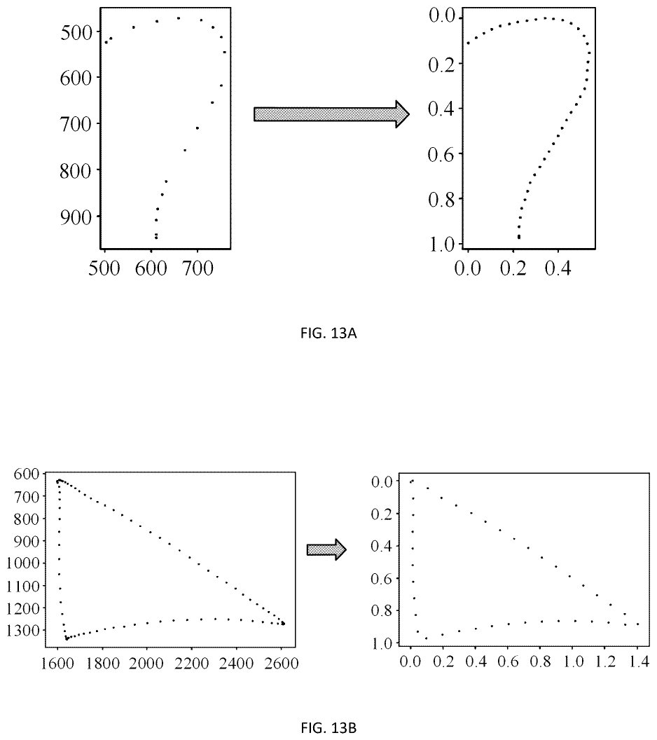

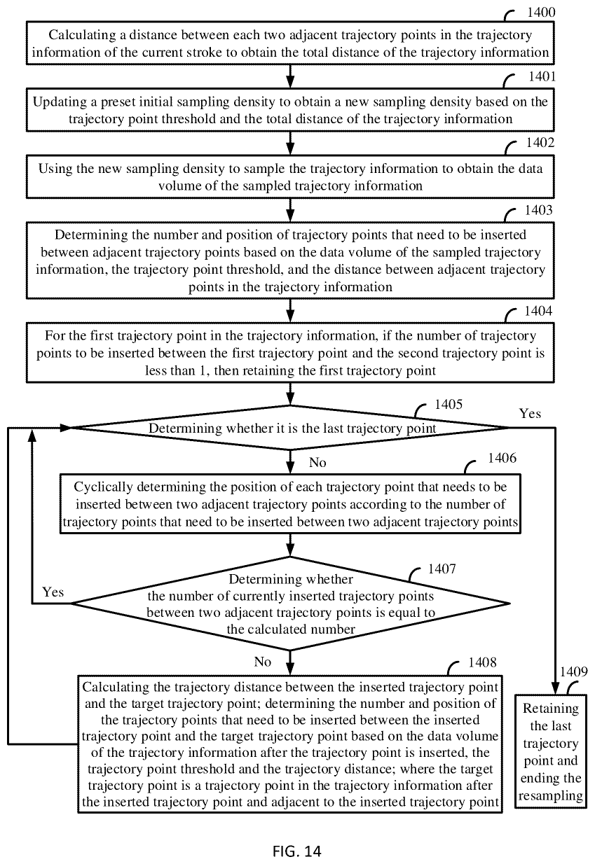

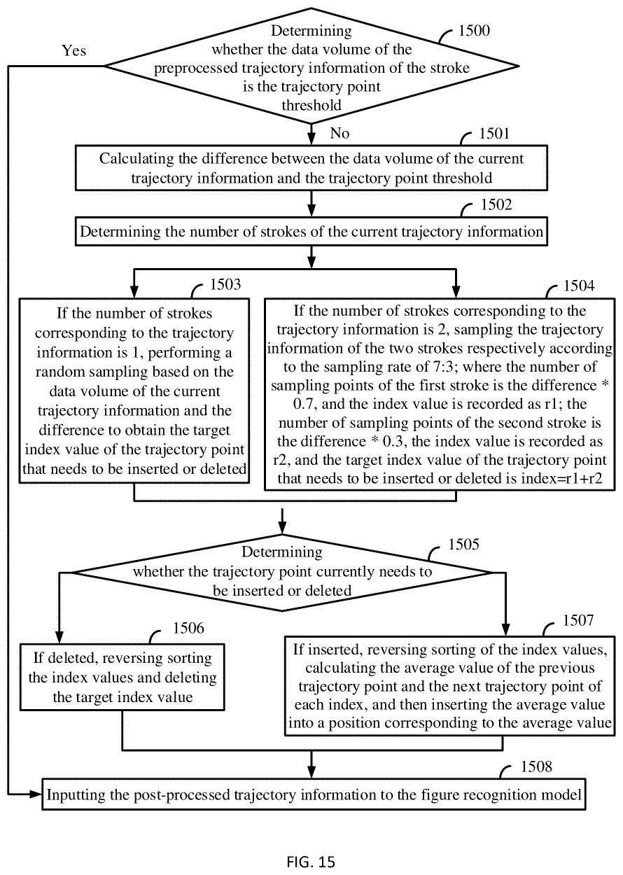

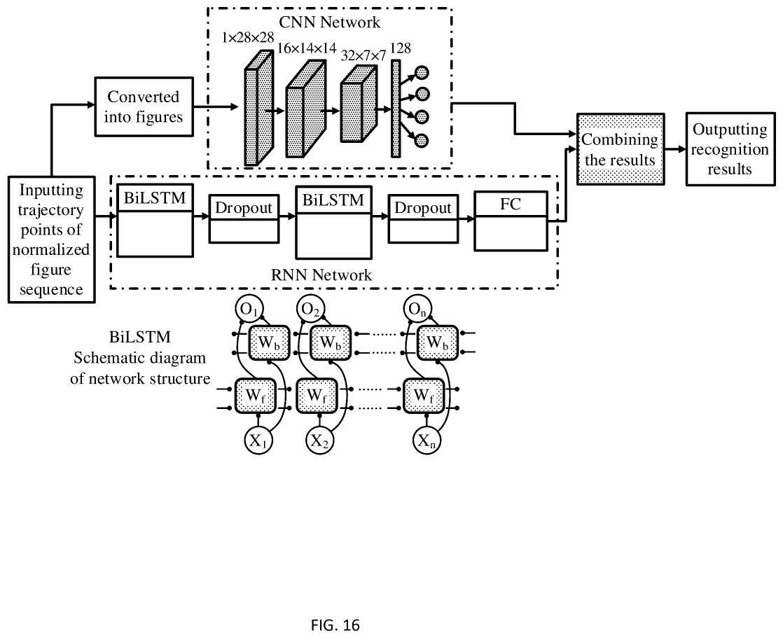

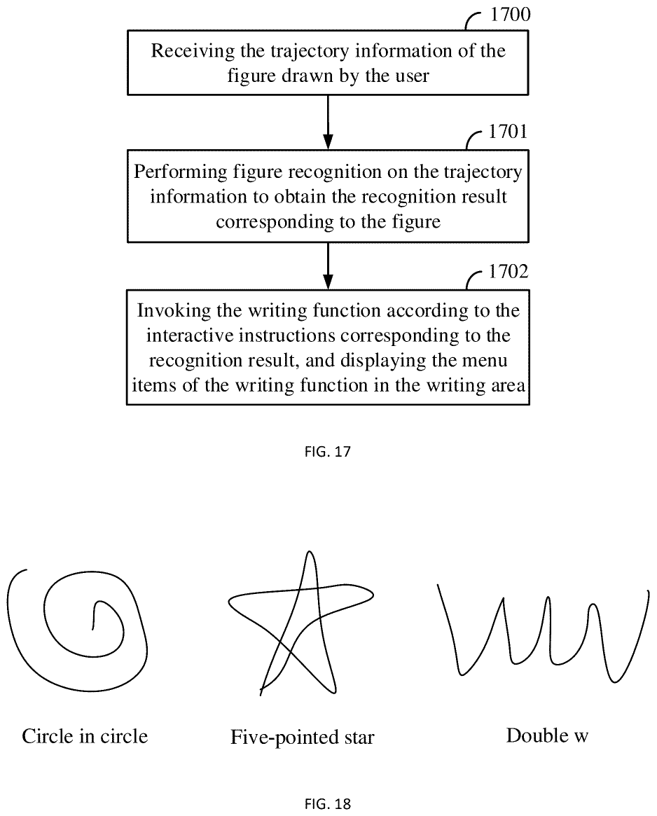

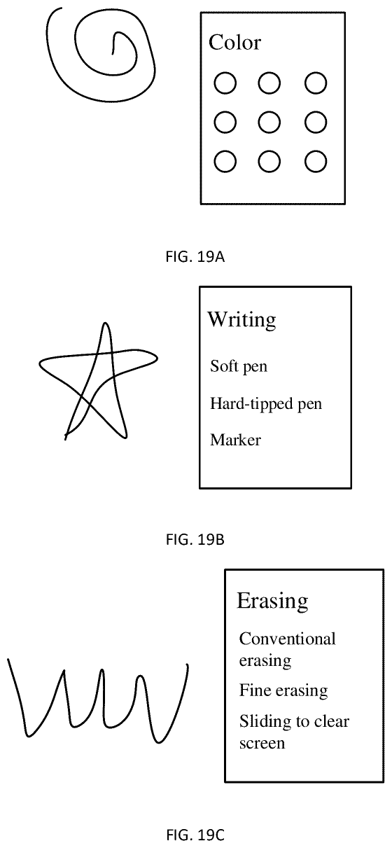

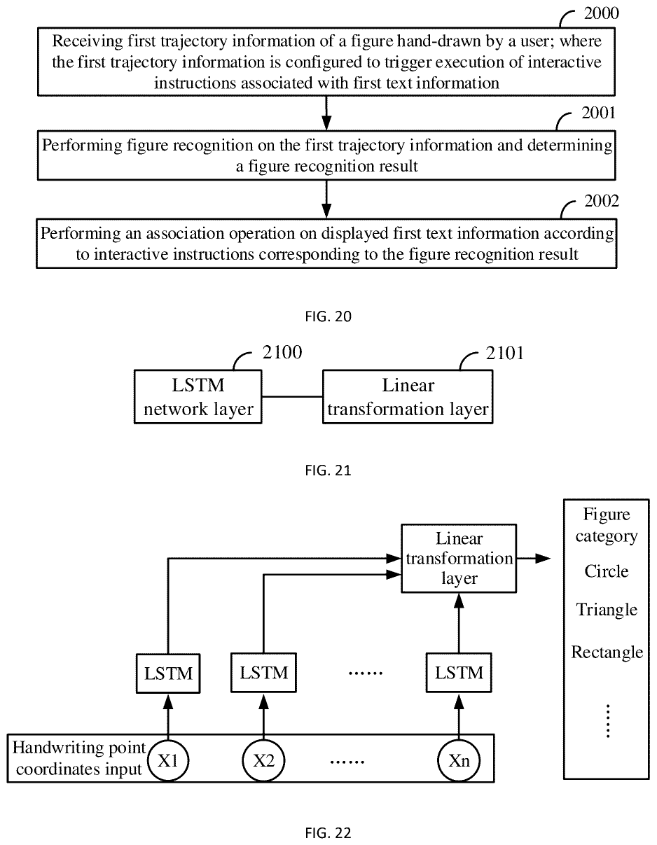

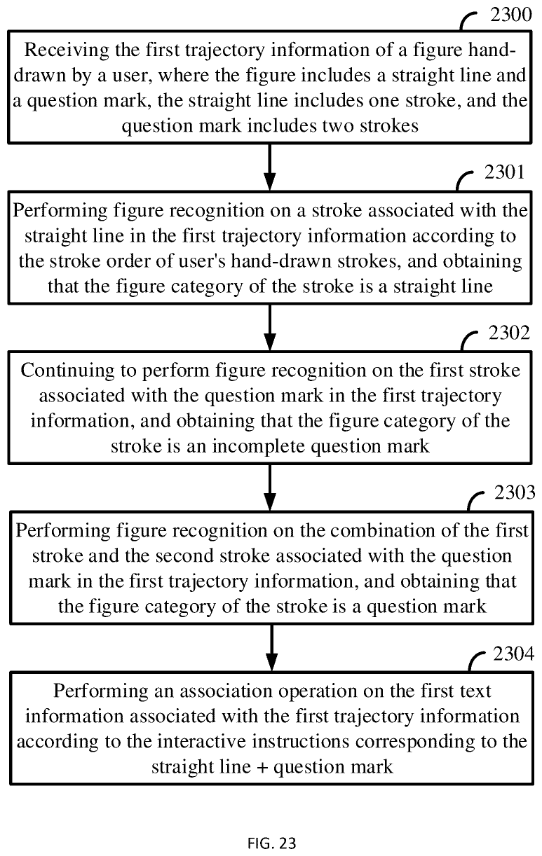

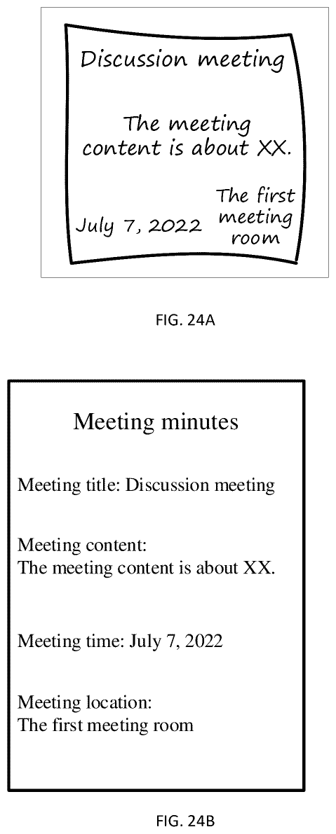

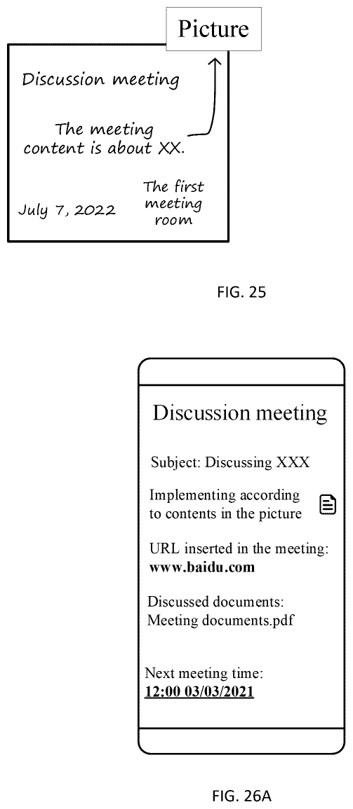

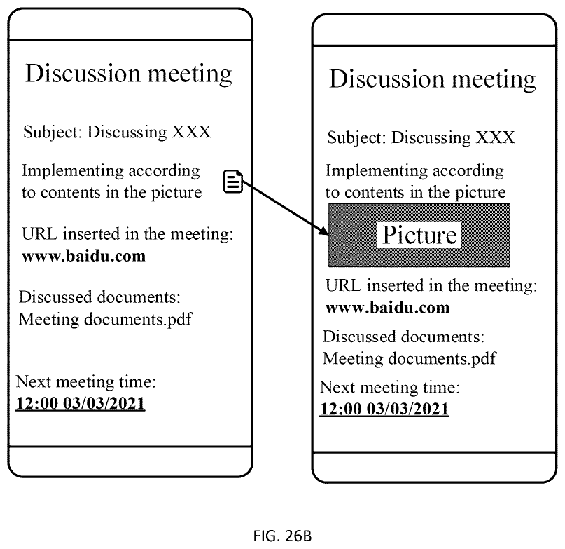

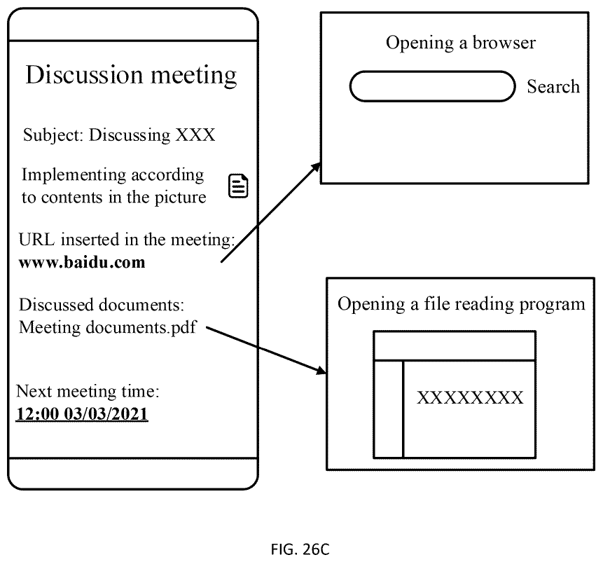

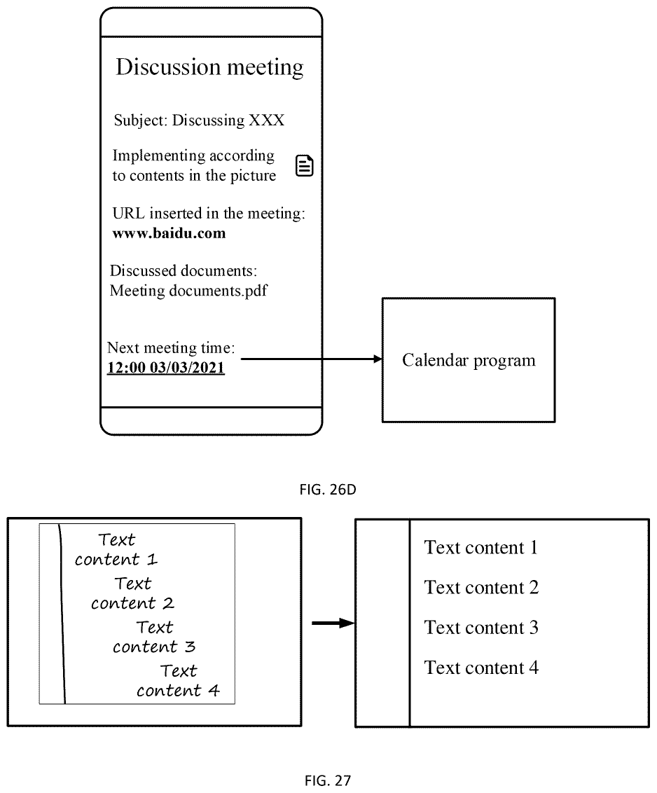

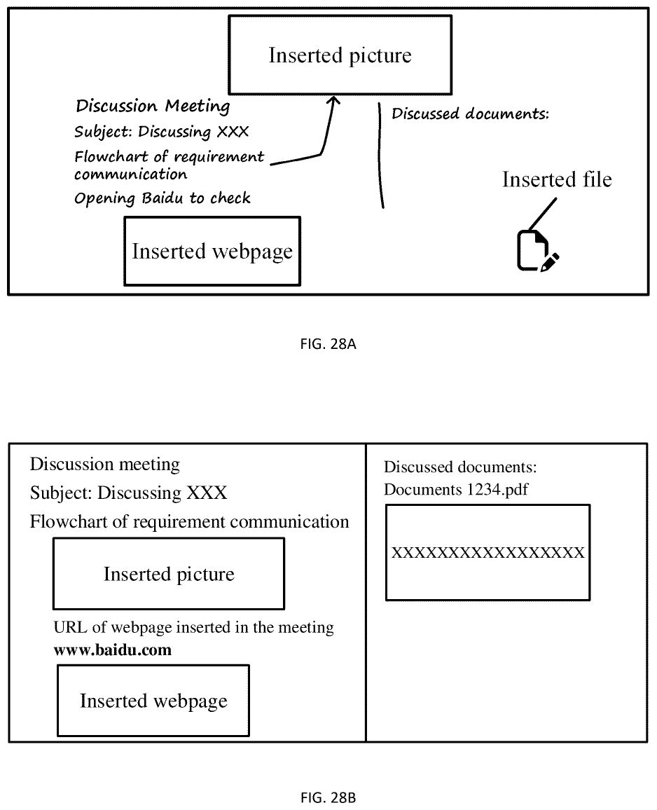

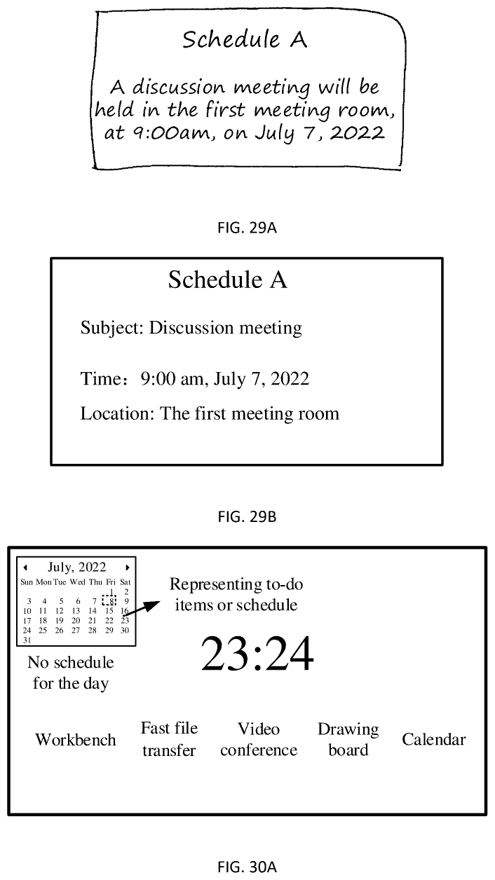

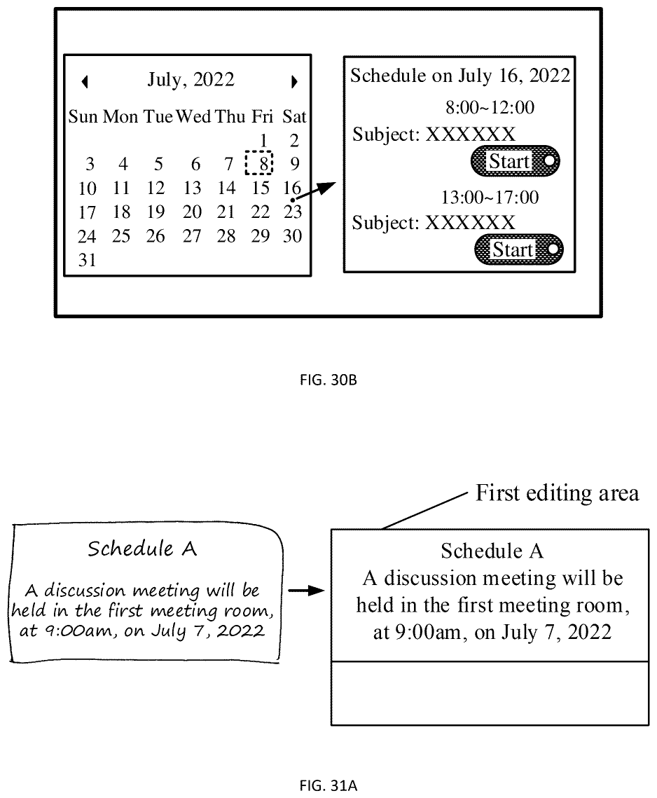

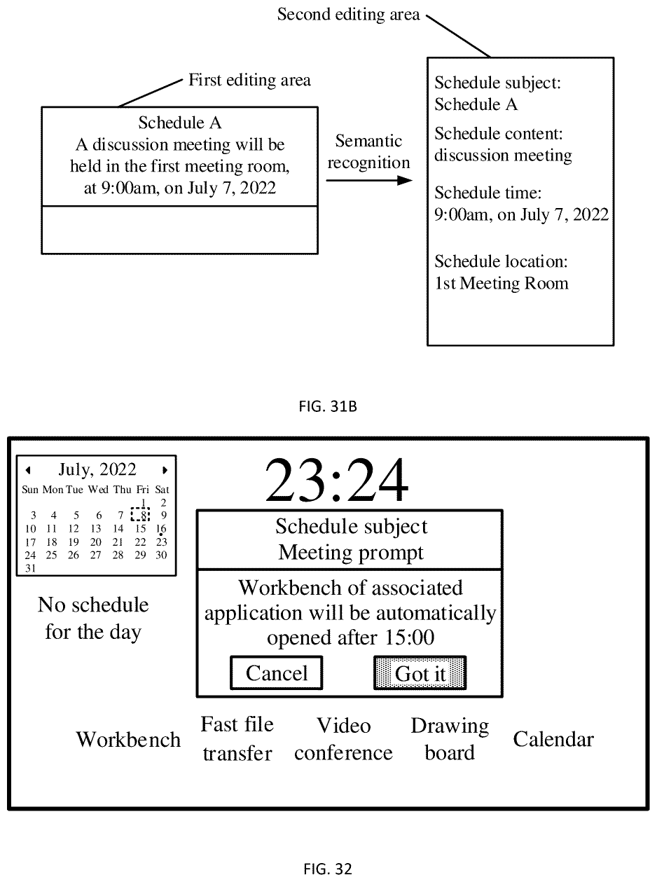

In some embodiments, as shown in FIG. 8, the embodiment provides an overall process of figure recognition interaction, including five key steps: (1) Rationality determination module configure to determine the rationality of trajectory information, and determine whether the trajectory information currently received is accidentally touched by the user, or is trajectory information that the user does not want to perform a certain function, etc; (2) Data preprocessing module, mainly including data normalization, resampling, format conversion and other operations; (3) Data post-processing module; (4) Figure recognition module; and (5) Function invoking module.

(1) Reasonability determination module.

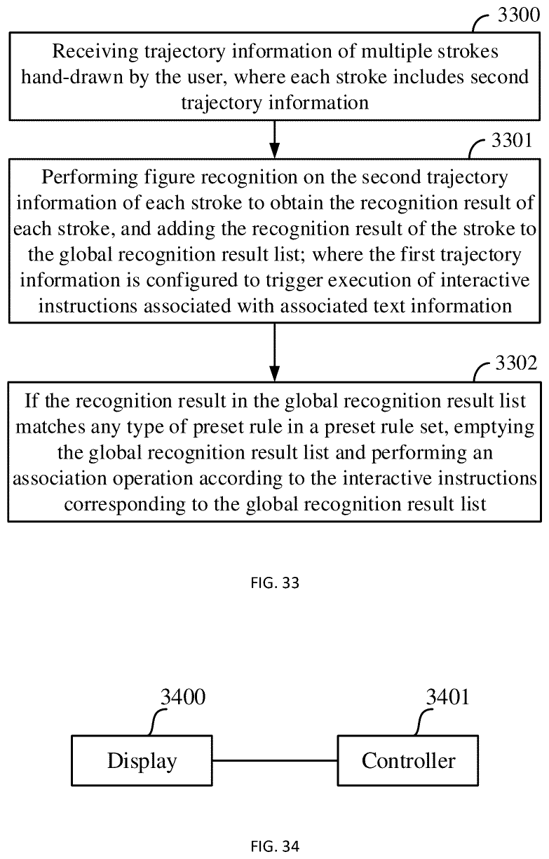

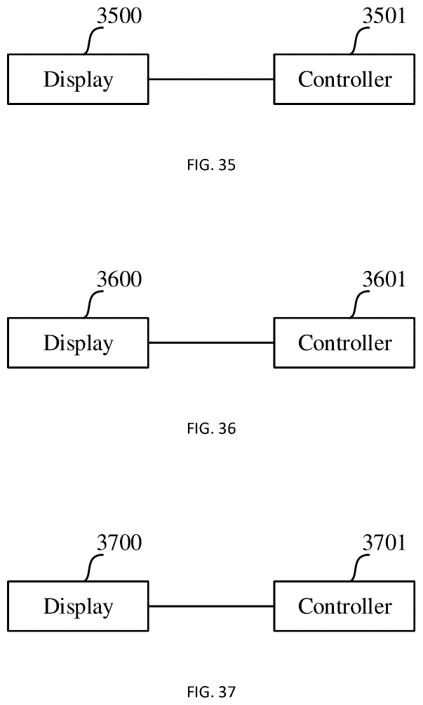

The embodiment can recognize a figure of a single stroke. When the user writes a stroke on the screen (from pressing the touch screen to leaving the screen), the operating system will immediately send the trajectory information currently received to the algorithm. At this time, if the trajectory information is directly input into the algorithm without making a preliminary determination on the user's operation, firstly, the operating system will invoke the figure recognition model to perform figure recognition, which wastes computing resources. Secondly, because the obtained trajectory information contains noise, the recognition rate of hand-painted figures is greatly reduced, thus reducing the interactivity of the product. In order to improve the figure recognition rate of the embodiment, the rationality determination module is proposed. As shown in FIG. 9, taking that the underline+question mark-like stroke+question mark are used as the preset rules, and the interactive instructions corresponding to the preset rules are to query the content of the area above the underline as an example. The embodiment further provides a rationality determination process, as follows:
Step 900: receiving the trajectory information of a stroke drawn by the user in real time;
Step 901: determining whether the global recognition result list is empty, if yes, proceeding to step 902; otherwise, proceeding to step 904;
Step 902: determining whether the data volume of the input trajectory information is greater than the trajectory point threshold, if yes, proceeding to step 903; otherwise, proceeding to step 906;
Step 903: preprocessing the trajectory information;
Step 904: determining whether the current stroke is the second stroke of the question mark, if yes, proceeding to step 905; otherwise, proceeding to step 907;
Step 905: combining the trajectory information of the current stroke and the trajectory information of the previous stroke to obtain the combined trajectory information, and proceeding to step 903;
Step 906: ending;
Step 907: emptying the global recognition result list.

During the implementation, if it is determined that the current global recognition result list is empty, it means that the previously obtained trajectory information is not an underline, or the user has not used the touch screen for input. At this time, it determines again that whether the data volume of the input trajectory information is greater than the trajectory point threshold, for example, the trajectory point threshold is set to 3. If the data volume of the trajectory information (i.e., the number of trajectory points) is greater than the threshold of 3, the obtained trajectory information will be subject to data preprocessing. Otherwise, the obtained trajectory information will be considered as noise data and no figure recognition will be performed.

If the current global recognition result list is not empty, the length of the global recognition result list is determined at this time. If the length is 1, a normal data preprocessing is performed. If the length is 2, it means that the underline and the question mark-like stroke have been recognized, which means that the user currently most likely wants to use the underline+question mark function. At this time, it is necessary to determine whether the current stroke is the second stroke of the question mark. If it is the second stroke of the question mark, the first stroke and the second stroke of the question mark are combined together and sent to the data preprocessing module for data preprocessing. If it is not the second stroke of the question mark, it means that the user does not currently want to use the underline+question mark function, and the global recognition result list will be emptied.

It should be noted that the setting of the trajectory point threshold in this embodiment is associated with actual required functions. If the method of this embodiment is used on other similar products, the threshold can be changed.

In some embodiments, before performing figure recognition on the first trajectory information of each figure, the method further includes:
preprocessing the first trajectory information of each figure to remove noise in the first trajectory information, and converting the first trajectory information of the same figure with different specifications into a unified standard data.

In some embodiments, the trajectory information of the stroke is preprocessed in any one or more of the following methods.

Method 1: removing identical trajectory points in the first trajectory information of the figure.

During implementation, when users draw and write on the touch screen, the trajectory points sampled by the hardware may be repeated due to factors such as each user's writing speed and writing habits. For example, the situation where the writing pen stays on the display screen after the user writes, may cause the same sampling point to be sampled at the stay position, which needs to be deleted. The first step in data preprocessing is to eliminate the same sampling points (i.e., trajectory points) in the same stroke, so that the obtained coordinates of the trajectory points of each stroke are valid.

Method 2: performing normalization processing on the first trajectory information of the figure to obtain normalized first trajectory information, where the normalization processing is configured to convert the first trajectory information of the figure into information of a fixed size.

Since the sizes of figures drawn by each user on the screen are different, the trajectory information needs to be normalized in order to be processed effectively. In the implementation, the trajectory information of the strokes is normalized in any of the following ways.

Method 2a: if the ratio of the height and width of the figure is less than a threshold, using the height and width of the figure to update Y coordinate of the trajectory point contained in the first trajectory information of the figure, and normalizing the updated first trajectory information according to the width of the figure.

In the implementation, the height and width of the figure can be determined based on the minimum value and maximum value of the X coordinate and the minimum value and maximum value of the Y coordinate in the first trajectory information. Generally drawn figures can be roughly divided into two categories: flat or tall and thin. During normalization processing, different normalization values need to be used for normalization of these two different categories of figures.

It should be noted that the first trajectory information and trajectory information in this embodiment have the same meaning.

Taking the figure in the embodiment containing one stroke as an example, the height H and width W of the figure are calculated first based on the maximum coordinate (x_max, y_max) and minimum coordinate (x_min, y_min) in the trajectory information of one stroke. They are as follows:

$$H = y\_max - y\_min ; W = x\_max - x\_min ;$$

when H/W is less than a threshold, such as 0.2, the figure is considered flat. In order to normalize this type of figure to be in the middle of 0-1, it is necessary to first increase all the y-axis coordinate values of this type of figure.

The calculation formula is:

$$y\_new = 0.5 * W - 0.5 * H + y ;$$

y represents the y-axis coordinate in the trajectory information of the stroke, and y_new represents the y-axis coordinate after the trajectory information of the stroke has been translated upward along the y-axis coordinate.

At this time, the upward-translated trajectory information is normalized with the W value. The normalization calculation method is as follows:

$$x\_norm = ( x - x\_min ) / W ; y\_norm = ( y\_new - y\_min ) / W ;$$

(x_norm, y_norm) is the normalized trajectory information of the upward-translated trajectory information (x, y_new).

As shown in FIGS. 10A-10B, the embodiment provides a schematic diagram of the normalization effect (shown in FIG. 10B) of a flat stroke (shown in FIG. 10A), in which the maximum width of the normalized trajectory information is 1.

Method 2b: If the ratio of the height and width of the figure is not less than the threshold, normalizing the first trajectory information of the figure according to the height of the figure.

In the implementation, if H/W is not less than 0.2, normalization is performed according to the height H. The calculation method is as follows:

$$x\_norm = ( x - x\_min ) / H ; y\_norm = ( y - y\_min ) / H ;$$

(x_norm, y_norm) is the trajectory information after normalizing the trajectory information (x, y).

As shown in FIGS. 11A-11B, taking a figure containing one stroke as an example, the embodiment provides a schematic diagram of the normalization effect (shown in FIG. 11B) of a tall and thin stroke (shown in FIG. 11A), the maximum height of the normalized trajectory information is 1.

In the implementation, the purpose of normalization processing is to change the first trajectory information of all obtained figures to a unified size, and normalize trajectory points of different sizes and shapes to 0-1, which can reduce the difference between the first trajectory information to reduce the differences within figure categories.

Method 3: performing resampling processing on the first trajectory information of the figure, where the resampling processing is configured to ensure that the data volume of the first trajectory information after the figure is resampled is within a preset range.

In the implementation, the purpose of resampling is to unify the point number of strokes of all shapes so that the number of coordinate points of each shape are consistent, which can improve the recognition ability of the figure recognition model and also improve the inference time of the model, and is not affected by the size of the strokes.

In some embodiments, if the data volume of the normalized first trajectory information obtained after normalizing the first trajectory information of the figure is not equal to the trajectory point threshold, then the first trajectory information of the figure is resampled.

In some embodiments, the first trajectory information of the figure is resampled through the following steps.

Step 1) sampling the first trajectory information using a new sampling density to obtain data of the sampled first trajectory information.

The new sampling density is obtained by updating a preset initial sampling density based on a trajectory point threshold and a total distance of the first trajectory information;
the total distance of the first trajectory information is the sum of distances of adjacent trajectory points in the first trajectory information.

As shown in FIG. 12, the embodiment provides a schematic diagram of the first trajectory information of a sampled figure, where di represents a distance between adjacent trajectory points, L represents the total distance of the first trajectory information, (xi, yi) represents the i-th trajectory point of the first trajectory information, (xi−1, yi−1) represents the (i−1)^{th} trajectory point of the first trajectory information, i is an integer greater than 0; the distance formula is as follows:

$${d}_{i} = \sqrt{{( {x}_{i} - {x}_{i - 1} )}^{2} + {( {y}_{i} - {y}_{i - 1} )}^{2}} ; L = {\sum }_{i = 1}^{n} {d}_{i} ;$$

n is the data volume of the first trajectory information, that is, the total data volume of the trajectory points in the sampled first trajectory information.

The new sampling density is determined based on the trajectory point threshold and the total distance of the first trajectory information by the following formula:

$$Δ = ratio \times ⌈ ( L * m ) / k ⌉ ;$$

Δ represents the new sampling density, ratio represents the initial sampling density, for example, ratio=0.1; L represents the total distance of the first trajectory information, k represents the trajectory point threshold, for example, setting k=40; m represents the amplification coefficient, for example, m being setting to 10.

The first trajectory information is sampled according to the new sampling density to obtain the data volume of the sampled first trajectory information. The formula is as follows:

$$num = int ( \frac{L}{Δ} ) ;$$

num represents the data volume of the first trajectory information after sampling, L represents the total distance of the first trajectory information, Δ represents the new sampling density, and int represents rounding.

Step 2) determining the number and position of trajectory points that need to be inserted between adjacent trajectory points according to the data volume of the sampled first trajectory information, the trajectory point threshold and the distance between adjacent trajectory points in the first trajectory information.

During implementation, it is determined by the following formulas:

$$λ = \frac{sample\_i}{{d}_{i}} ; len\_list = \frac{{d}_{i}}{L} \times K ;$$

$$re\_x = ( 1 - λ ) {x}_{i} + λ {x}_{i - 1} ; re\_y = ( 1 - λ ) {y}_{i} + λ {y}_{i - 1} ;$$

A represents the proportion of inserted trajectory points, sample_i represents the distance from the 0th trajectory point to the i-th trajectory point, di represents the distance between the (i−1)th trajectory point and the i-th trajectory point, and k represents the trajectory point threshold, len_list represents the number of trajectory points that need to be inserted between the (i−1)th trajectory point and the i-th trajectory point, (xi, yi) represents the i-th trajectory point of the first trajectory information, (xi−1, yi−1) represents the (i−1)th trajectory point of the first trajectory information, i is an integer greater than 0, and (re_x, re_y) represents the position of the inserted trajectory point.

Step 3) resampling the first trajectory information according to the number and position of trajectory points that need to be inserted between adjacent trajectory points.

Optionally, if multiple trajectory points need to be inserted between adjacent trajectory points, after inserting one trajectory point, the trajectory distance between the inserted trajectory point and the target trajectory point is calculated, where the target trajectory point is a trajectory point after the inserted trajectory point and adjacent to the inserted trajectory point in the first trajectory information; the number and position of the trajectory points that need to be inserted between the inserted trajectory point and the target trajectory point are determined according to the data volume of the first trajectory information after the inserted trajectory point is inserted, the trajectory point threshold and the trajectory distance.

In the implementation, the preset initial sampling density is first updated to obtain a new sampling density based on the set trajectory point threshold and the total distance of the first trajectory information, and then the new sampling density is used to resample the first trajectory information of the stroke to obtain the sampled first trajectory information, and determine the number and position of trajectory points that need to be inserted between adjacent trajectory point based on the data volume of the sampled first trajectory information, the trajectory point threshold, and the distance between each adjacent trajectory points in the first trajectory information. When one trajectory point is inserted between two adjacent trajectory points, one more trajectory point is inserted between the inserted trajectory point and the later trajectory point of the two adjacent trajectory points until all resampling is completed.

Since the embodiment is mainly aimed at terminal touch electronic products, the chip computing capabilities of such electronic products are not high. Secondly, the function of underline+question mark will be activated when the computer is turned on, so the occupation of this function on memory and computing power usage of the electronic products should be reduced as much as possible. Therefore, the embodiment samples a preset number of coordinate points, such as 40 coordinate points, for a stroke of any shape. Furthermore, since the present disclosure can perform normalization and resampling processing, the user can write at any position on the screen of the electronic product, and there are no requirements on the length or size of the user's writing or drawing, improving interactivity and convenience.

Method 4: converting the first trajectory information of the figure into a data format required for figure recognition.

In some embodiments, the format conversion is performed as follows:
converting the first trajectory information into a data format required for figure recognition according to the coordinates of the first trajectory information, the state of the writing medium corresponding to the first trajectory information, and whether the first trajectory information is a starting point.

Optionally, after each stroke is normalized and resampled, the coordinate points of each stroke can be converted into the data format input by the figure recognition model. The input data format of the figure recognition model includes but is not limited to four dimensions: [x, y, pen_state, pen_start], x, y represents a coordinate point on each stroke, pen_state represents the current status of pen, and pen_start represents whether the current pen is the starting point. Therefore, the trajectory information of each stroke will become the following format [[x0, y0, 1, 1], [x1y1, 1, 0], . . . , [xn, yn, 0, 0]]. The data after normalization and resampling can be converted into a format that satisfies the input of the figure recognition model.

In some embodiments, the above-mentioned methods 1-4 can be used in combination. The embodiment does not place too many restrictions on the order of the above-mentioned four methods when used in combination. For example, during preprocessing, the same trajectory points in the trajectory information of the strokes can be removed first, and then the trajectory information of the strokes can be normalized to obtain normalized trajectory information. The normalized trajectory information is resampled, and the resampled trajectory information is converted into a preset data format.

Method 5: processing a situation where the trajectory information of the stroke is a trajectory point.

When the received trajectory information is a trajectory point, whether the global recognition result list is empty is first determined, if the global recognition result list is empty at this time, the trajectory information is discarded, indicating that the user accidentally touched it; if the global recognition result list is not empty, then whether the trajectory information is the second stroke of the question mark is determined, if yes, the trajectory information and the trajectory information of the previous stroke are combined and further subjected to normalization processing; otherwise, the global recognition result list is emptied and an abnormal result is returned.

As shown in FIGS. 13A and 13B, the embodiment further provides a comparison diagram before and after data resampling. After the resampling process, the data volume of the trajectory information can be unified within the range of the trajectory point threshold floating up and down, that is, the preset range, for example, after resampling, the total number of trajectory points of the trajectory information of the stroke can be equal to or close to 40.

As shown in FIG. 14, the embodiment further provides an implementation process of data resampling, as shown below:
Step 1400, calculating the distance between each two adjacent trajectory points in the trajectory information of the current stroke to obtain the total distance of the trajectory information;
Step 1401, updating the preset initial sampling density to obtain a new sampling density based on the trajectory point threshold and the total distance of the trajectory information;
Step 1402, using the new sampling density to sample the trajectory information to obtain the data volume of the sampled trajectory information;
Step 1403, determining the number and position of trajectory points that need to be inserted between adjacent trajectory points based on the data volume of the sampled trajectory information, the trajectory point threshold, and the distance between adjacent trajectory points in the trajectory information;
Step 1404, for the first trajectory point in the trajectory information, if the number of trajectory points to be inserted between the first trajectory point and the second trajectory point is less than 1, then retaining the first trajectory point;
Step 1405, determining whether it is the last trajectory point, if yes, proceeding to step 1409; otherwise, proceeding to step 1406;
Step 1406, cyclically determining the position of each trajectory point that needs to be inserted between two adjacent trajectory points according to the number of trajectory points that need to be inserted between two adjacent trajectory points;
Step 1407, determining whether the number of currently inserted trajectory points between two adjacent trajectory points is equal to the calculated number, if yes, proceeding to step 1405; otherwise, proceeding to step 1408;
Step 1408, calculating the trajectory distance between the inserted trajectory point and the target trajectory point; determining the number and position of the trajectory points that need to be inserted between the inserted trajectory point and the target trajectory point based on the data volume of the trajectory information after the trajectory point is inserted, the trajectory point threshold and the trajectory distance; where the target trajectory point is a trajectory point in the trajectory information after the inserted trajectory point and adjacent to the inserted trajectory point; returning to step 1405;
Step 1409, retaining the last trajectory point and ending the resampling.

In some embodiments, during the resampling process, since the result of the sampling density calculation is a floating point number, the number of trajectory points after all final resampling is not necessarily the set trajectory point threshold. When the data volume of the trajectory information after resampling is not equal to the trajectory point threshold, the trajectory information needs to be completed or points deleted.

In some embodiments, after preprocessing the trajectory information of the stroke, if the data volume of the preprocessed trajectory information of the stroke is not equal to the trajectory point threshold, trajectory points are deleted or inserted in the trajectory information in order to ensure that the data volume of the trajectory information is equal to the trajectory point threshold.

In some embodiments, the embodiment deletes or inserts trajectory points in the first trajectory information in the following manner:
determining the sampling method according to the number of strokes contained in the figure corresponding to the first trajectory information;
using the sampling method to sample the first trajectory information to obtain the index value of the trajectory point that needs to be inserted or deleted; and
inserting a trajectory point based on the index value of an inserted trajectory point, or deleting a trajectory point based on the index value of a deleted trajectory point.

It should be noted that the purpose of reverse sorting the indexes of trajectory points that need to be deleted or inserted is to not affect the index of the previous first trajectory information after operating on the first trajectory information. For example, when two trajectory points need to be inserted into a set of first trajectory information, the position index values of the two trajectory points in the first trajectory information are 5 and 7. If the insertion is performed in positive order, after inserting a trajectory point at the 5th position, the previously calculated position at the 7th position will become the 8th position of the new data. Every time a point is inserted during this operation, the new inserted point calculated last time needs to be changed. In order to solve this problem, the embodiment sorts the indexes of the inserted points in reverse order, inserting or deleting from back to front. Each insertion or deletion of a trajectory point will not affect the first calculated index value of the inserted trajectory point.

In some embodiments, the sampling method is determined as follows:
if the number of strokes contained in the figure corresponding to the first trajectory information is 1, then randomly sampling the first trajectory information;
if the number of strokes contained in the figure corresponding to the first trajectory information is greater than 1, sampling each figure according to a sampling rate corresponding to each figure.

In the implementation, the first trajectory information after data preprocessing includes at least the following two cases.

Case 1: the number of strokes corresponding to the first trajectory information is 1.

At this time, the current figure only has one stroke, and a trajectory point can be randomly selected to operate.

Case 2: the number of strokes corresponding to the first trajectory information is greater than 1.

If the current figure contains two strokes, it means that there is a high probability that the current figure is a “question mark”, that is, the first trajectory information that the user is preprocessing may be the first trajectory information after combining the two strokes of the question mark. First the number of points in the second stroke is calculated. If the number of points in the second stroke is less than the preset value such as 5, the points in the first stroke can be directly interpolated or deleted. Otherwise, the first trajectory information of the two strokes is processed in a preset ratio such as 7:3 (first stroke:second stroke). The purpose of data post-processing in this embodiment is to ensure that the length of each first trajectory information input to the figure recognition model is a specified length, such as the trajectory point threshold set in the embodiment.

After the first trajectory information received in the implementation has been preprocessed by normalization, resampling, etc., the data volume of the first trajectory information will change to near the trajectory point threshold, because in the calculation of the resampling algorithm, the data is a floating point number operation, so after data resampling, the number of data points may not all be equal to the trajectory point threshold. Some first trajectory information will be less than the trajectory point threshold, and some first trajectory information will be more than the trajectory point threshold. In order to make the data volume of all first trajectory information strictly equal to the trajectory point threshold, the embodiment designs a data post-processing module to delete or insert the first trajectory information so that the data volume of preprocessed first trajectory information of the figure is equal to the trajectory point threshold.

As shown in FIG. 15, taking the figure including one stroke as an example, the first trajectory information of the figure includes the trajectory information of the stroke. The embodiment provides an implementation flow of data post-processing as follows:
Step 1500, determining whether the data volume of the preprocessed trajectory information of the stroke is the trajectory point threshold, if yes, proceeding to step 1508; otherwise, proceeding to step 1501;
Step 1501, calculating the difference between the data volume of the current trajectory information and the trajectory point threshold;
Step 1502, determining the number of strokes of the current trajectory information;
Step 1503, if the number of strokes corresponding to the trajectory information is 1, performing random sampling based on the data volume of the current trajectory information and difference to obtain a target index value of the trajectory point that needs to be inserted or deleted;
Step 1504, if the number of strokes corresponding to the trajectory information is 2, sampling the trajectory information of the two strokes respectively according to the sampling rate of 7:3; where the number of sampling points of the first stroke is the difference*0.7, and the index value is recorded as r1; the number of sampling points of the second stroke is the difference*0.3, the index value is recorded as r2, and the target index value of the trajectory point that needs to be inserted or deleted is index=r1+r2;
Step 1505, determining whether the trajectory point currently needs to be inserted or deleted;
Step 1506, if deleted, reverse sorting the index values and deleting the target index value;
Step 1507, if inserted, after reverse sorting the index values, calculating an average value of the previous trajectory point and the next trajectory point of each index, and then inserting into a position corresponding to the average value;
Step 1508, inputting the post-processed trajectory information to the figure recognition model.

In some embodiments, the embodiment performs figure recognition on the first trajectory information of each figure through the following steps:
using a figure recognition model to perform figure recognition on the first trajectory information of the figure, where the figure recognition model includes a convolutional neural network, CNN, and a recurrent neural network, RNN; and
inputting the first trajectory information of the figure into the convolutional neural network and the recurrent neural network respectively for feature extraction, and obtaining a first feature output by the convolutional neural network and a second feature output by the recurrent neural network, combining the first feature and the second feature to obtain a combined feature, and classifying the combined feature to obtain a recognition result corresponding to the first trajectory information of the figure.

In some embodiments, the recurrent neural network includes a two-layer network and a fully connected layer, the two-layer network includes a bidirectional long-short memory network and a Dropout layer. The first trajectory information of the figure is sequentially input to the two-layer network and the fully connected layer, and the second feature is output.

In some embodiments, to facilitate the application of the method of the present disclosure on terminal electronic products, the figure recognition model adopts a lightweight network structure, specifically using a CNN+RNN network structure, as shown in FIG. 16. RNN uses two layers of BiLSTM (bidirectional long-short memory network). In order to improve the model recognition rate, a dropout layer is added after each layer, and the dropout coefficient is set to 0.5. Then a layer of FC (fully connected layer) is added. The input and output of each layer of the network are shown in the table below, ‘None’ represents the batch size during training.

| | | |
|---|---|---|
| Input layer | input | (None, 40, 4) |
| | output | (None, 40, 4) |
| BiLSTN | input | (None, 40, 4) |
| | output | (None, 40, 128) |
| BiLSTN | input | (None, 40, 128) |
| | output | (None, 40, 128) |
| FC | input | (None, 40, 128) |
| | output | (None, 128, 5) |

Optionally, the first trajectory information is configured to trigger the execution of interactive instructions associated with the associated text information, and perform associated operations on the displayed text according to the interactive instructions corresponding to the global recognition result list.

In some embodiments, the embodiment provides any one or more of the following ways to perform association operations.

Method 1: if the user draws multiple figures on a document display page, determining content of a to-be-queried area based on interactive instructions corresponding to the multiple figures, circling the content of the to-be-queried area, and performing query operation.

During the implementation, the query function can be invoked. For example, if the user draws an underline and a question mark, the global recognition result list stores recognition results of underline, question mark-like stroke and question mark. At this time, the to-be-queried area above the underline is determined according to the corresponding query interaction instruction, the content in the to-be-queried area is circled and query operation is performed.

Method 2: if the user draws multiple figures on the display page of the writing software, invoking writing-related functions according to the interactive instructions corresponding to the multiple figures.

During implementation, the brush function, eraser function, etc. can be invoked. For example, if the user wants to change the shape of the brush during writing, a five-pointed star can be drawn to directly pop up a brush function selection menu for the user to choose.

In some embodiments, the preset rules in this embodiment include two figure category sets arranged in a preset order. The two figure category sets include a first figure category set and a second figure category set. The first figure category set includes one or more first figure categories, and the second figure category set includes one or more second figure categories. The first figure category set or the second figure category set is configured to perform text selection operations.

It should be noted that the first figure category and the second figure category in the embodiment are two different types defined in advance. The definition of the figure category has nothing to do with the category of the figure. For example, the first figure category includes straight lines, rectangular boxes, elliptical frame, etc. The second figure category includes figures such as exclamation points, question marks, quotation marks, etc.

Optionally, the first figure category set is configured to perform text selection operations, and the second figure category set is configured to trigger the execution of interactive instructions.

In the implementation, for example, when the first figure category set includes a straight line and a rectangular frame, the text in the area above the straight line or within the rectangular frame can be used as the selected text. If the second figure category set includes a question mark, the selected text can be queried.

In some embodiments, the preset rules in this embodiment include a first figure category set and a second figure category arranged in a preset order; or, a first figure category set and a first figure category set arranged in a preset order.

In the implementation, when the preset rules include a first figure category set and a second figure category set arranged in a preset order, for example, the first figure category set includes lines and rectangular frames, and the second figure category set includes exclamation points and question marks, and when the user hand-draws a straight line and a question mark in sequence, it matches the straight line in the first figure category set sequenced in the preset rule and the question mark in the second figure category set. At this time, the associated operations of interactive instructions corresponding to the straight line+question mark can be performed.

In the implementation, when the preset rules include a first figure category set and a first figure category set arranged in a preset order, for example, the first figure category set includes straight lines and rectangular frames, when the user hand-draws a straight line and the other straight line in sequence, it matches the straight line in the first figure category set and the straight line in the first figure category set that are sequentially arranged in the preset rule. At this time, the associated operations of the interactive instructions corresponding to the straight line+straight line can be performed. For another example, when the user hand-draws a straight line and then a rectangular frame in sequence, which match the straight line in the first figure category set and the rectangular frame in the first figure category sets sequentially in the preset rule, in this case, the association operations of the interactive instructions corresponding to the straight line+rectangular frame can be performed.

In some embodiments, the text is determined based on the recognition results matching the first figure category in the global recognition result list, and the interactive instructions are determined based on the recognition results matching the second figure category in the global recognition result list; association operations are performed on the text according to the interactive instructions.

In some embodiments, if the user draws multiple figures on the document display page, the content of the to-be-queried area is determined based on the interactive instructions corresponding to the multiple figures, and the content of the to-be-queried area is circled and the query operation is performed. Alternatively, if the user draws multiple figures on the display page of the writing software, the writing-related functions are invoked according to the interactive instructions corresponding to the multiple figures.

Based on the same inventive concept, embodiments of the present disclosure further provide an interaction method based on figure recognition, as shown in FIG. 17. The specific process of implementing this method is as follows:
Step 1700, receiving the trajectory information of the figure drawn by the user;
Step 1701, performing figure recognition on the trajectory information to obtain the recognition result corresponding to the figure;
Step 1702, invoking the writing function according to the interactive instructions corresponding to the recognition result, and displaying menu items of the writing function in the writing area.

During the implementation, the system obtains the trajectory information input on the screen in real time, and then inputs the obtained trajectory information to the figure recognition model. The model performs the figure recognition on the input trajectory information. During recognition, the obtained trajectory information is first normalized and resampled. The preprocessed trajectory information is input to the figure recognition model for recognition. The system judges the recognition results and invokes different function selection interfaces based on the recognition results. The function selection item pops up at the current writing position in the writing interaction area of the screen. The user selects the desired function according to the pop-up function selection items.

In order to achieve the above effects, a figure recognition model needs to be embedded in the display device system. This model needs to have the characteristics of small model, small calculation amount, and high accuracy. When the display device is turned on and the workbench operating software is opened, the system will automatically invoke the model.

In the implementation, in the scenario of the writing software of the display device, the functions can be divided into three types: brush color selection, brush type selection, and eraser type selection. As shown in FIG. 18, the embodiment provides a schematic diagram of an implementation of a hand-drawn figure. For these three types of functions, three figures can be designed to represent respectively: brush color selection—circle within a circle, brush type selection—pentagon, eraser type selection—double W, other types of input are considered negative samples.

In the implementation, first the format of the trajectory information input by the user is obtained:
Points:[{‘x1’:20, ‘y1’:30, ‘time’:15107109, ‘isLeave’: False},
{‘x1’:22, ‘y1’:33, ‘time’:15107122, ‘isLeave’: False},
{‘x1’:25, ‘y1’:34, ‘time’:15107145, ‘isLeave’: False},
. . . ,
{‘x1’:80, ‘y1’:90, ‘time’:15108370, ‘isLeave’: True}
the format of the trajectory information input by the user on the screen is defined as shown above, which mainly includes x, y coordinate information, time information of each point, and status information of whether each point is writing or leaving the screen.

During implementation, in order to make the figure recognition model small and have high accuracy, the embodiment samples 40 coordinate points for a stroke of any shape; second, this function can be implemented to write at any position on the screen of the display device, there are no requirements for length, and size. Therefore, the present disclosure will first normalize the obtained trajectory information to 0-1, and normalize figures of different sizes and shapes to 0-1, which can reduce the differences within figure categories.

During implementation, in order to improve the operating efficiency of the system, the present disclosure uses two layers of BiLSTM+one fully connected layer to build a figure recognition model. The model input is the normalized and resampled sequence trajectory points, and the input is the probability of four types of figures. Finally, the type of input trajectory points can be calculated through the softmax function.

First a global recognition result list is defined. The list stores recognition results of figures, and the recognition results include two types: (1) one-stroke forming result; (2) a combination of multiple figures recognition results.

The one-stroke forming result means that one figure can invoke the corresponding function of the display device; the combination of multiple figure recognition results means that the invoking of a function requires a combination of multiple simple figures. For example, if drawing three straight lines, an operation of saving reading notes is performed.

The specific implementation process is as follows:
1) obtaining, by the system, the trajectory information input by the user in real time, and simultaneously performing denoising, resampling, and normalization operations on the trajectory information;
2) inputting the processed trajectory information into the figure recognition model, recognizing, by the model, the input figure, and storing the recognition results in the global recognition results list;
3) logically judging results in the global recognition result list.

If the length of the current global recognition result list is 1 and the result is the single-stroke instruction figure, the corresponding instruction is directly invoked and the global recognition result list is emptied at the same time.

If the length of the global recognition result list of the current result is 1, and the result is not the single-stroke instruction figure, but one of multiple strokes, for example, the first stroke (straight line) of drawing 3 straight lines+an exclamation mark as defined, then the recognition result is stored while continuing to receive, by the system, input from the user until all figures meet the defined results and the length of the global recognition result list is equal to the number of defined figures, the corresponding instruction is invoked and the global recognition result list is emptied.

If the length of the current global recognition result list is 1, but the recognition result is not the result of any of the defined figure, the global recognition result list is directly emptied, waiting for the next input of the user (This situation may be the user's normal writing operation, not an attempt to invoke a certain function of the display device).

During implementation, as shown in FIGS. 19A to 19C, this embodiment provides a schematic diagram of invoking the writing function. When the system receives that the result output from the model is a “link” of a certain type of function, the system will invoke the functional interface, and then a function selection item pops up at the user's current writing position for the user to choose.

It should be noted that the method of this embodiment can not only be configured to invoke writing-related function buttons during writing interaction, but can also be extended to other software, similar to the invoking of custom function button shortcuts. The figure recognition model in this embodiment supports most of the commonly used single-stroke figures, and users can customize functions corresponding to these figures. At the same time, users can also customize their own figures. The specific operations are: 1) The user selects a custom figure function; 2) The user draws a shape of a self-defined figure on a screen at least 20 times; 3) The user clicks to complete the drawing. The system inputs all the collected trajectory information drawn by the user into the automated model training; 4) The model training takes approximately 15-20 minutes, after which the user can use the customized figures to invoke the specific functions of the corresponding display device.

In addition, in this embodiment, in addition to a single-stroke figure being directly defined as a certain instruction, a combination of multiple figures can also be defined as an instruction, such as defining three straight lines+an exclamation point to represent an editing instruction; three circles represent an instruction of saving after editing, etc.

Based on the same inventive concept, embodiments of the present disclosure also provide an interaction method based on figure recognition, as shown in FIG. 20. The specific process of implementing this method is as follows:
Step 2000: receiving first trajectory information of a figure hand-drawn by a user; where the first trajectory information is configured to trigger the execution of interactive instructions associated with first text information;
Step 2001: performing figure recognition on the first trajectory information and determining a figure recognition result; and
Step 2002: performing association operations on the displayed first text information according to the interactive instruction corresponding to the figure recognition result.

It should be noted that the user-drawn figure in the embodiment include one or more sub-figures; the first trajectory information includes but is not limited to the sub-trajectory information of one sub-figure or the sub-trajectory information of multiple sub-figures, each sub-figure can be completed by one or more strokes, that is, the sub-trajectory information includes one stroke trajectory or multiple stroke trajectories.

The hand-drawn figures in the embodiment include, but are not limited to, at least one of plane figures of various shapes, various types of lines, special characters, punctuation marks, or arithmetic symbols. For example, the hand-drawn figures include, but are not limited to at least one of triangle, rectangle, circle, diamond, straight line, wavy line, curve, arrow, question mark, exclamation mark, asterisk, or a plus sign.

The first text information in the embodiment includes, but is not limited to at least one of text written by the user, printed text, PDF text, WORD text, or text in picture format. The first text information in the embodiment generally includes the medium of text content. The embodiment does not place too many restrictions on the specific form of the first text information.

In some embodiments, before receiving the first trajectory information of the user's hand-drawn figures, the handwriting information of the text written by the user is received, and the first text information is determined based on the handwriting information. The first text information in the embodiment may be handwriting information written by the user, or may be information obtained after format conversion of the handwriting information. In the implementation, when the display interface does not have the first text information, after receiving the first trajectory information of the user's hand-drawn figures, the first trajectory information is directly displayed, or the figure recognition is performed on the first trajectory information, and the recognition results are displayed. Optionally, the first text information in the embodiment can also be any document, such as a PDF document, a WORD document and other documents in various formats.

In some embodiments, the first text information is determined based on received handwriting information written by the user. The first text information is determined in any of the following ways:
Method 1: receiving the handwriting information of the text written by the user, performing trajectory recognition on the handwriting information to determine the trajectory recognition result; replacing the handwriting information with the trajectory recognition result, displaying the trajectory recognition result in a preset format, and determining the displayed trajectory recognition result as the first text information;
Method 2: receiving and displaying the handwriting information of the text written by the user, and determining the displayed handwriting information as the first text information.

In some embodiments, the figure includes multiple sub-figures, and the first trajectory information includes sub-trajectory information of the multiple sub-figures.

Figure recognition is performed on the first trajectory information in the following manner to determine the figure recognition result:
receiving sub-trajectory information of multiple sub-figures hand-drawn by the user, performing the figure recognition on the sub-trajectory information of each sub-figure to obtain the first recognition results corresponding to the multiple sub-figures; and determining the figure recognition result based on the multiple first recognition results.

Optionally, the order of figure recognition is not limited. The sub-trajectory information belonging to the same sub-figure can be filtered out from the sub-trajectory information of multiple sub-figures hand-drawn by the user according to a preset time threshold, and then the sub-trajectory information belonging to one sub-figure can be recognized.

In some embodiments, the figure recognition can further be performed sequentially in the following manner:
receiving the sub-trajectory information of the multiple sub-figures in sequence according to the order of multiple sub-figures hand-drawn by the user; recognizing each sub-trajectory information in figure in sequence according to the order in which the multiple sub-trajectory information is received, to obtain the corresponding first recognition results, and saving the first recognition results.

In the implementation, the sub-trajectory information of multiple sub-figures is received in sequence according to the order of multiple sub-figures drawn by the user; each time the sub-trajectory information of a sub-figure is received, figure recognition is performed on the sub-trajectory information to obtain the corresponding first recognition result, and then the first recognition result is saved; and the final figure recognition result is determined based on the saved first recognition results corresponding to the multiple sub-figures.

In some embodiments, when the order of received sub-figures and the first recognition results corresponding to the sub-figures satisfy a preset interaction strategy, the first recognition results corresponding to the sub-figures is saved.

In some embodiments, after saving the first recognition result, when the current sub-figure is not the last sub-figure in the interaction strategy, the position range of the next sub-figure of the current sub-figure is determined according to the interaction strategy. When the next sub-figure is not received within the position range, the saved first recognition result corresponding to the sub-figure is emptied.

In the implementation, when the current sub-figure is not the last sub-figure in the interaction strategy, the position range of the next sub-figure of the current sub-figure is determined according to the interaction strategy; waiting for receiving the sub-trajectory information of the next sub-figure within the position range, if the sub-trajectory information of the next sub-figure is received within the position range, then continuing to perform figure recognition on the sub-trajectory information of the next sub-figure; if the sub-trajectory information of the next sub-figure is not received within the position range, stopping receiving the sub-trajectory information of the next sub-figure and emptying all the saved first recognition results.

In some embodiments, after obtaining the first recognition results respectively corresponding to multiple sub-figures, the embodiment may further determine and implement the interactive instructions corresponding to the figure recognition results in sequence in the following manner:
obtaining the recognition order of the first recognition results respectively corresponding to the multiple sub-figures, and when the recognition order satisfies the preset order, determining to execute the interactive instructions corresponding to the first recognition results.

In some embodiments, taking the sub-figure including at least a first stroke and a second stroke as an example, the first recognition results corresponding to multiple sub-figures are obtained in the following manner:
recognizing the first stroke to obtain a first recognition result, and when the first recognition result is an incomplete figure, saving the first stroke; where the incomplete figure means that the original figure includes multiple strokes, and the incomplete figure indicates that some strokes in the original figure are missing;
according to the coordinate range of the missing second stroke, receiving the second stroke within the coordinate range, and recognizing the first stroke and the second stroke together to obtain a first recognition result.

In some embodiments, when the received first recognition result of the current sub-figure is an incomplete figure, saving the sub-trajectory information of the current sub-figure; according to the number of missing strokes and the coordinate range of the incomplete figure, waiting for receiving the sub-trajectory information corresponding to the missing stroke within the coordinate range; performing figure recognition on the saved sub-trajectory information of the current sub-figure and the sub-trajectory information corresponding to the missing stroke to obtain the first recognition result corresponding to the combination of the incomplete figure and the missing stroke.

In the implementation, the interaction strategy in the embodiments includes at least one figure or multiple figures and the writing order of the multiple figures. For example, when the interaction strategy is straight line+question mark, when the user draws a “straight line” by hand, the first recognition result is a straight line, saving the recognition result of straight line and waiting for receiving next figure. At this time, the interactive instruction will still not be triggered. When the user draws the “incomplete question mark”, e.g., a dot in the question mark is missed, the first recognition result is “question mark-like stroke”, saving the recognition result of “question mark-like stroke”, and waiting for receiving the next figure in the lower position range of the user's hand-drawn “incomplete question mark”. At this time, the interactive instruction is still not triggered. When the user hand-draws “dot”, performing figure recognition on the combination of the user's hand-drawn “incomplete question mark” and “dot”, to obtain and save the first recognition result, and determining the figure recognition result based on each first recognition result. When the figure recognition result satisfies the interaction strategy, the corresponding interactive instruction is executed.

In some embodiments, when the first recognition result and the order of the sub-figures corresponding to the first recognition result do not satisfy the preset interaction strategy, all saved first recognition results are emptied and the figure recognition ends.

In some embodiments, taking that the figure include a first sub-figure and a second sub-figure, the first trajectory information includes first sub-trajectory information of the first sub-figure and second sub-trajectory information of the second sub-figure as an example, the process of implementing the interactive instructions in the embodiment is as follows:
receiving the first sub-trajectory information, performing figure recognition on the first sub-trajectory information to obtain the first recognition result of the first sub-figure; when the first recognition result of the first sub-figure is the first sub-figure, saving the first recognition result of the first sub-figure;
receiving the second sub-trajectory information, performing figure recognition on the second sub-trajectory information to obtain the first recognition result of the second sub-figure; when the first recognition result of the second sub-figure is the second sub-figure, implementing the interactive instructions corresponding to the first sub-figure and the second sub-figure.

In some embodiments, receiving the second sub-trajectory information, and performing figure recognition on the second sub-trajectory information to obtain the first recognition result of the second sub-figure, further includes:
when the first recognition result of the second sub-figure is not the second sub-figure, emptying the saved first recognition result of the first sub-figure.

In the implementation, in the embodiment, the user draws hand-drawn figures to perform association operations on the displayed text. By recognizing the first trajectory information of the hand-drawn figures, the corresponding interactive instructions are determined, thereby performing corresponding operations on the written text. For example, in a meeting scenario, after the user has finished writing the meeting content, the meeting content can be annotated graphically to perform association operations on the annotated meeting content. The annotated meeting content can also be recognized by annotating the meeting content, so as to automatically generate meeting minutes based on the recognition results. The text written by the user can also be graphically annotated, the annotated text can be recognized, so as to automatically generate to-do items based on the recognition results.

In some embodiments, the figure in the embodiment includes a first sub-figure and a second sub-figure. The interactive instruction corresponding to the figure recognition result of the first sub-figure is configured to determine the range of the first text information associated with the interactive instruction. The interactive instruction corresponding to the figure recognition result of the second sub-figure is configured to determine the interaction type, different interaction types perform different association operations on the first text information.

For example, if the user draws a “straight line”+“question mark” under the first line of the first text information, the first association operation is performed on the first line of text information; if the user draws a “straight line”+“exclamation mark” under the first line of the first text information, the second association operation is performed on the text information of the first line.

In some embodiments, the embodiment can further perform the following association operations on the displayed first text information:
according to the interactive instructions corresponding to the figure recognition results, aligning each row of text and/or each column of text in the displayed first text information.

In some embodiments, an association operation is performed on the displayed first text information according to the interactive instructions corresponding to the recognition results in the following manner:
determining the first text information associated with the first trajectory information according to the relationship between the first trajectory information and display positions of the first text information; and performing association operations on the first text information associated with the first trajectory information according to the interactive instructions corresponding to the recognition results.

In some embodiments, the first text information may be determined in the following manner:
receiving the handwriting information of the text written by the user, performing trajectory recognition on the handwriting information to determine the trajectory recognition result; replacing the handwriting information with the trajectory recognition result, and displaying the trajectory recognition result in a preset format, and determining displayed trajectory recognition result as the first text information.

In some embodiments, the first text information is handwriting information of text written by the user.

The step of performing association operations on the first text information associated with the first trajectory information according to the interactive instruction corresponding to the recognition result includes:
according to the interactive instruction corresponding to the recognition result, replacing the first text information associated with the first trajectory information with a format corresponding to any one of a preset title, a preset subtitle, or a preset paragraph.

In some embodiments, the trajectory recognition results are displayed in a preset format in the following manner:
according to the corresponding relationship between the writing position of the handwriting information of the text and the preset row text position or preset column text position in the current writing area, determining the preset format corresponding to the trajectory recognition result of the handwriting information; and displaying the trajectory recognition results according to the corresponding preset format.

In some embodiments, according to the relative positional relationship between the handwriting information and the current writing area, the trajectory recognition results of the user's handwriting information are displayed in any one or more of the following ways.

Method 1: when the writing position of the handwriting information of the text is the first row of text position or the first column of text position in the current writing area, the trajectory recognition result is displayed as a title corresponding to the preset title format.

In some embodiments, the font of the displayed title is a font of a preset format, such as black, bold. Optionally, the font size of the displayed title is determined based on the largest font size in the line of text written by the user. For example, the largest font size in the first line of text is 20 (px)×20 (px), and the font size of the title is 11.

Method 2: when the writing position of the handwriting information of the text is the second row of text position or the second column of text position in the current writing area, the trajectory recognition result is displayed as a subtitle corresponding to the preset subtitle format.

In some embodiments, the font of the displayed subtitle is a font of a preset format, such as boldface. Optionally, the font size of the subtitle is determined based on the largest font size in the line of text written by the user.

Method 3: when the writing position of the handwriting information of the text is the row text position after the second line or the column text position after the second column in the current writing area, the trajectory recognition result is displayed as the paragraph content corresponding to a preset paragraph format.

In some embodiments, the font of the displayed paragraph content is a font of a preset format, such as Song typeface. Optionally, the size of the font in the paragraph content is determined based on the largest font size in the third line of text written by the user.

During the implementation, in the meeting minutes scenario, when the user writes text, the handwriting information of the text will be automatically converted into titles, subtitles, and paragraph content, thereby automatically formatting the text written by the user, solving the problem that the user's handwritten content is messy and cannot be organized, and providing a more convenient way to improve the user experience.

In some embodiments, when performing title recognition, the user opens the handwriting software, the first line of written text is automatically recognized as the title of the current content, where the font of the title is a predefined first standard font. When saving the text, the text can also be named and saved according to this title. When performing subtitle recognition, the second line of text written by the user is automatically recognized as a subtitle. The font of the subtitle is a predefined second standard font. The subtitle can also be automatically indented by 2 characters. During paragraph recognition, the third line of text and the text after the third line written by the user are automatically recognized as paragraph content and automatically indented. If the paragraph content is not neat, the distance between adjacent lines will be automatically adjusted according to the preset line spacing to keep the line spacing consistent throughout the paragraph.

In some embodiments, the trajectory recognition results are displayed in a preset format in the following manner:
according to the corresponding relationship between the font size in the handwriting information of the text and the preset range, determining the preset format corresponding to the trajectory recognition result of the handwriting information; and displaying the trajectory recognition result according to the corresponding preset format.

In some embodiments, the trajectory recognition result is displayed in the corresponding preset format in any one or more of the following ways:
Method 4: when a font size in the handwriting information of the text meets a first preset range, displaying the trajectory recognition result as a title corresponding to a preset title format;
Method 5: when a font size in the handwriting information of the text meets a second preset range, displaying the trajectory recognition result as a subtitle corresponding to a preset subtitle format;
Method 6: when a font size in the handwriting information of the text meets a third preset range, displaying the trajectory recognition result as paragraph content corresponding to a preset paragraph format.

The first preset range is greater than the second preset range, and the second preset range is greater than the third preset range.

In some embodiments, in this embodiment, the above methods 1 and 4 can be implemented in combination, the above methods 2 and 5 can be implemented in combination, and the above methods 3 and 6 can be implemented in combination. The solutions implemented in combination will not be described again here. In the implementation, on the one hand, the preset format of the trajectory recognition result of the current line of handwriting information can be determined based on the position of the text written by the user; on the other hand, the preset format of the trajectory recognition result of displayed handwriting information of the current line can be determined based on the size of the font of the current line written by the user. Finally, the position and font size of the text written by the user can also be combined to determine the preset format of the trajectory recognition result of the current line of handwriting information. The preset format in the embodiment includes but is not limited to font type, font size, whether it is bold, whether it is underlined, and other types of formats.

In some embodiments, the embodiment may further determine the first text information in the following manner:
receiving and displaying handwriting information of the text written by the user, and determining displayed handwriting information as the first text information.

It should be noted that the first text information in the embodiment may be the handwriting information of the text written by the user, or may be the trajectory information obtained by converting the handwriting information, which is not too limited in this embodiment.

In some embodiments, the embodiment performs figure recognition on the first trajectory information in the following manner to determine the figure recognition result.

In a first method, one of the sub-figures in the user's hand-drawn figures includes one stroke.

In the implementation, the figure recognition is performed on the stroke trajectory to determine the figure recognition result.

For example, the user hand-draws a circle or rectangle including one stroke, and performs the figure recognition on the one stroke to determine that the figure recognition result is a circle or rectangle.

In a second method, one of the sub-figures in the user's hand-drawn figures includes multiple strokes.

In the implementation, according to the stroke order of the sub-figure hand-drawn by the user, the figure recognition is performed on the combination of multiple strokes with continuous stroke order to determine the figure recognition result.

When including multiple strokes, there are multiple cases as follows:
Case 1) multiple strokes are multiple figures, each figure includes one stroke;
Case 2) multiple strokes form one figure;
Case 3) multiple strokes are multiple figures, and each figure includes multiple strokes;
Case 4) multiple strokes are multiple figures, at least one figure includes one stroke, and at least one figure includes multiple strokes.

In the implementation, in all the above cases, the multiple strokes can be sequentially recognized according to the stroke order of the sub-figures hand-drawn by the user. When the figure recognition result of the stroke is a complete figure, the next stroke can be continued to be recognized. When the figure recognition result of the stroke is an incomplete figure, the stroke is retained first, and the stroke and at least one consecutive stroke after the stroke are recognized as a whole until it is determined that the recognition result is a complete figure.

In some embodiments, the figure recognition result is determined by sequentially performing figure recognition on the combination of multiple consecutive strokes in the stroke sequence in the following manner:
(1) when the figure recognition result of the stroke is an incomplete figure, determining the number and coordinate range of the missing strokes in the incomplete figure;
(2) according to the number and coordinate range, determining at least one consecutive stroke after the stroke;
(3) performing figure recognition on the combination of the stroke and at least one consecutive stroke after the stroke, and determining the figure recognition result.

In the implementation, taking the user hand-drawing a question mark “?” as an example. The question mark includes two strokes. When the first stroke hand-drawn by the user is recognized in figure and the figure recognition result of the stroke is determined to be an incomplete figure, the number and coordinates of the missing strokes are determined, that is, it is determined that a stroke is missing and the coordinates of the missing stroke should be located below the first stroke, a stroke below the first stroke is determined according to the number and coordinates, figure recognition is performed on a combination of the stroke and the first stroke, that is, figure recognition is performed on the stroke and the first stroke as a whole, and it is determined that the figure recognition result is a question mark.

In some embodiments, the figure recognition in the embodiment includes but is not limited to optical character recognition (OCR), which refers to a process of an electronic device (such as a scanner or digital camera) checking characters printed on the paper and determining shape of the characters by detecting dark and bright modes, and then using character recognition methods to translate the shape into computer text. The OCR is also used for text recognition, trajectory recognition, etc.

The OCR recognition can be divided into three stages according to the processing method: pre-processing, text recognition or figure recognition, and post-processing. The pre-processing mainly includes grayscale, binarization, noise removal, tilt correction, etc. The figure recognition mainly includes CNN+RNN+CTC, or CNN+RNN+Attention (attention model).

The figure recognition algorithm or trajectory recognition algorithm in the embodiment includes but is not limited to: at least one of EAST, CTPN, SegLink, PixelLink, TextBoxes, TextBoxes++, TextSnake, or MSR.

Optionally, every time the user finishes writing a stroke, the OCR will be invoked to save the current figure, so that the relevant strokes can be intercepted for subsequent figure recognition.

In the implementation, the embodiment can perform figure recognition through a LSTM+linear (linear transformation layer) network. The number of layers of the LSTM network structure can be determined according to the difficulty and time-consuming nature of the task. For example, one or more layers are used. The parameter bidirectional of LSTM is set to true, which means using bidirectional LSTM and using the input before-and-after information. The linear is a linear transformation layer, configured to output the specified dimension. As shown in FIG. 21, the embodiment provides a figure recognition model, including an LSTM network layer 2100 and a linear transformation layer 2101. An RNN network with additional structures can also be used as needed, and a classification loss function can be used for RNN training. The LSTM is configured to extract features from the input strokes to obtain stroke features, and the linear is configured to classify the input stroke features and determine the figure category and coordinates of the stroke.

As shown in FIG. 22, the embodiment further provides a schematic diagram for figure recognition of input strokes, in which each stroke received is determined according to each pen-down and pen-up action of the user, and the handwriting point coordinates in each stroke are input to the LSTM+linear transformation layer linear for recognition according to the order of writing, i.e., the order of received strokes, and the figure category corresponding to the stroke is obtained. The handwriting points of each stroke can be sparsely processed and then input to LSTM+linear for recognition to improve recognition efficiency.

As shown in FIG. 23, the embodiment provides a multi-stroke interaction process. The specific steps for implementing this process are as follows:
Step 2300: receiving the first trajectory information of a user's hand-drawn figure, the figure includes a straight line and a question mark, the straight line includes one stroke, and the question mark includes two strokes;
Step 2301: performing figure recognition on a stroke associated with a straight line in the first trajectory information according to the stroke order of the user's hand-drawn strokes, and obtaining that the figure category of the stroke is a straight line;
Step 2302: continuing to perform figure recognition on the first stroke associated with the question mark in the first trajectory information, and obtaining that the figure category of the stroke is an incomplete question mark;
Step 2303: performing figure recognition on the combination of the first stroke and the second stroke associated with the question mark in the first trajectory information, and obtaining that the figure category of the stroke is a question mark;
Step 2304: performing an association operation on the first text information associated with the first trajectory information according to the interactive instructions corresponding to the straight line+question mark.

In some embodiments, the embodiment performs an association operation on the displayed first text information according to the interactive instructions corresponding to the recognition results in the following manner:
determining the first text information associated with the first trajectory information according to the relationship between the display positions of the first trajectory information and the first text information; and performing an association operation on the first text information associated with the first trajectory according to the interactive instructions corresponding to the recognition results. Optionally, in the embodiment, after the first text information associated with the first trajectory information is determined, the information of text format is first filtered out from the corresponding first text information, and then the association operation is performed according to the interactive instructions triggered by the user.

In the implementation, the embodiment can perform an association operation on part or all of the first text information that has been displayed through the first trajectory information. In the embodiment, the first text information associated with the first trajectory information is at least part of the first text information which has been displayed. An association operation is performed on the first text information associated with the first trajectory information according to the interactive instruction corresponding to the recognition result of the first trajectory information.

Optionally, the relationship between the display positions of the first trajectory information and the first text information in the embodiment includes but is not limited to at least one of: the first trajectory information completely surrounds the first text information, or the first trajectory information is located below the first text information, or the first trajectory information is located on at least one side of the first text information. It should be noted that the relationship between the display positions of the first trajectory information and the first text information in the embodiment is only an implementation, and the purpose is to use the first trajectory information to perform annotation, association operations, etc. on the first text information. Other positional relationships based on the inventive concept also fall within the protection scope of the present disclosure.

In some embodiments, the embodiment performs the following steps to perform an association operation on the first text information associated with the first trajectory information according to the interactive instructions corresponding to the recognition results:
performing text recognition on the first text information associated with the first trajectory information according to the interactive instruction of the recognition result, and obtaining and displaying a text recognition result.

In some embodiments, semantic recognition is performed on the first text information associated with the first trajectory information according to the interactive instruction of the recognition result, and meeting minutes or to-do items are generated according to the semantic recognition result.

The meeting minutes in the embodiment represent the meeting summary associated with the meeting content handwritten by the user in the meeting scenario, including but not limited to at least one of the meeting title, meeting content, meeting time, or meeting location. The to-do items in the embodiment represent content associated with the user's handwritten to-do items in the to-do item scenario, including but not limited to at least one of schedule subject, schedule content, schedule time, or schedule location.

In the implementation, after the user writes the text content in the writing software, the first trajectory information of the hand-drawn figures triggers text recognition and semantic recognition of the text written by the user, and the title, content, time, location, etc. in the text are recognized, thereby automatically generating meeting minutes or to-do items based on the recognized information according to different scenarios such as meeting scenarios or to-do scenarios, improving the user experience.

In some embodiments, the meeting minutes are generated based on at least one of meeting title, meeting content, meeting time, or meeting location in the semantic recognition result.

In the implementation, according to the predefined meeting minutes template, at least one of the meeting title, meeting content, meeting time, and meeting location is added to the corresponding position of the meeting minutes template, that is, the meeting title is added to the title position of the meeting minutes template, the time, location, and content are added to the corresponding locations in the meeting minutes template to automatically generate meeting minutes.

As shown in FIGS. 24A and 24B, the embodiment provides a display interface for automatically generating meeting minutes. In FIG. 24A, the user handwrites the meeting title, meeting content, meeting time and meeting location in the writing software to complete the meeting related text. After writing, the user specifies all or part of the conference-related text through hand-drawn figures. For example, the user surrounds all the written text with a hand-drawn rectangle. At this time, the execution of interactive instructions with the entire text is triggered, and the semantic recognition of the entire text is performed to obtain the meeting title, meeting content, meeting time and meeting location. Then, as shown in FIG. 24B, according to the preset meeting minutes template, the meeting title, meeting content, meeting time and meeting location obtained by the semantic recognition are added to the meeting minutes template respectively, to generate the meeting minutes.

In some embodiments, the embodiment can further insert pictures, web pages, files, etc., when writing text, and perform the following steps:
inserting at least one of pictures, web pages, or files associated with the first text information;
according to the interactive instructions corresponding to the recognition results, displaying inserted content in a hypertext markup language format.

In some embodiments, after inserting pictures associated with the first text information, the third trajectory information hand-drawn by the user can also be received, and the inserted pictures can be arranged on a side adjacent to the text position according to the text position pointed by the third trajectory information.

In the implementation, as shown in FIG. 25, the embodiment provides a display interface for inserting pictures. When the user inserts a picture into the writing software, it can also receive the user's hand-drawn arrow, use the arrow to connect the picture and text, and according to the text position pointed by the arrow, the inserted picture is arranged below the text position. The inserted picture and the text are displayed through HTML5 according to the interactive instructions corresponding to the recognition results of the first trajectory information hand-drawn by the user, so that the user can view the inserted pictures, web pages, files, etc. again.

In some embodiments, when the first text information further includes at least one of pictures, web pages, or files associated with the first text information, the meeting minutes are generated according to the semantic recognition results. At least one of the pictures, web pages, or files also can be added to the meeting minutes in a hypertext markup language format. Users can view the pictures, web pages, files and other content inserted by users in the meeting minutes again.

In the implementation, when the text information inserted with pictures, web pages, and files is recognized and meeting minutes are generated, the inserted content is displayed in HTML5 and added to the corresponding position in the meeting minutes. As shown in FIGS. 26A to 26D, the embodiment provides a display interface for generating meeting minutes. In FIG. 26A, the display interface displays the meeting title, the icon of the inserted picture, the URL link of the inserted web page, the name of the inserted file and the meeting time. When the user clicks the icon of the inserted picture, as shown in FIG. 26B, the inserted picture is displayed, and the display position of the content after the icon is automatically adjusted, as shown in FIG. 26C. When the user clicks the URL, the corresponding browser interface is opened to display the web page. When the user clicks on the name of the file, the file reading program is opened and the content of the file is displayed.

In some embodiments, the meeting minutes include the meeting time. The embodiment can also respond to the user's click operation on the meeting time, start the calendar program and add the meeting minutes as a to-do item to the calendar program. Alternatively, the first trajectory information associated with the meeting time is received, figure recognition is performed on the first trajectory information, and the figure recognition result is determined; the calendar program is started according to the interactive instructions corresponding to the figure recognition result, and the meeting minutes is added to the calendar program as a to-do item.

In the implementation, as shown in FIG. 26D, when the user clicks on the meeting time, the calendar program is opened, the meeting time is added to the corresponding date, and a to-do item generated by the meeting minutes is added to the calendar program as a reminder schedule.

Optionally, each row of text and/or each column of text in the displayed first text information is aligned according to the interactive instruction corresponding to the figure recognition result. As shown in FIG. 27, the embodiment provides a text alignment display interface. When the user draws a straight line on the left side of the written text, the printed text obtained after recognizing the text on the right side of the straight line is left aligned.

As shown in FIGS. 28A and 28B, the embodiment further provides a display interface for automatically converting text. As shown in FIG. 28A, when the user inserts pictures, web pages, and files into the written text, after the text written by the user is converted, as shown in FIG. 28B, the picture is inserted below the text connected by the arrow drawn by the user, and the web page and file are displayed in HTML5 format to facilitate the user's viewing.

In some embodiments, a to-do item is generated based on at least one of schedule subject, schedule content, schedule time, or schedule location in the semantic recognition result.

In the implementation, according to the predefined to-do template, the schedule subject, schedule content, schedule time, and schedule location are added to the corresponding positions of the to-do template respectively, thereby automatically generating a to-do item.

As shown in FIGS. 29A and 29B, the embodiment provides a display interface for automatically generating to-do items. In FIG. 29A, the user hand-writes the schedule subject, schedule content, schedule time, and schedule location of the to-do item, and then the user hand-draws a rectangle to place all the text of the handwritten to-do item inside the rectangle, and triggers the implementation of semantic recognition of all the text of the to-do item. As shown in FIG. 29B, the schedule subject, schedule content, schedule time, and schedule location obtained by the semantic recognition are added to the corresponding position in the preset to-do template to automatically generate the to-do items.

In some embodiments, the embodiment generates a to-do item based on the semantic recognition result, and can also determine the application program associated with the to-do item based on the application program associated with at least one keyword in the semantic recognition result. At the schedule time of the to-do item, the application program associated with the to-do item is started.

In the implementation, for example, when the semantic recognition results include the keywords “meet”, “meeting”, “discussion”, “remote”, etc., the to-do item is associated with the video conferencing application. When the semantic recognition results include the keywords “transfer”, “copy”, “file”, then the to-do item is associated with the fast file transfer application. When the semantic recognition results include the keywords “writing”, “handwriting”, “record”, “minutes”, “table”, the to-do item is associated with the workbench application. When the semantic recognition results include the keywords “figure”, “picture”, “drawing”, and “sketch”, the to-do item is associated with the drawing pad. When the semantic recognition results include the keywords “retrieval”, “search”, “query”, and “webpage” in the semantic recognition results, the to-do item is associated with the browser. When the schedule time of the to-do item is reached, the application program associated with the to-do item is started.

In some embodiments, as shown in FIGS. 30A and 30B, the embodiment further provides a smart calendar scenario. In this scenario, the calendar program is displayed in the form of a window on the homepage of the desktop launcher, and the calendar program shows schedules for different dates. In the implementation, the floating window of the calendar program displays the dates of the current month by default, and dates with schedules (to-do items) are marked with reminders. Users can view the added schedules. The added schedules are displayed in the order of their start time. When the start times of different schedules are consistent or conflict, the conflicting schedules are displayed in the order of the time when the schedules were added. When the content of the schedule exceeds the display range of the display area, it can be displayed through pull-down or slide-down operation. When the user does not add a schedule for the current day, it prompts “No schedule for the day”. Users can also manually open or close the calendar program. When the application associated with the to-do item is already open at the schedule time of the to-do item, a pop-up window is no longer pop up to remind the user. When the application associated with the to-do item is not opened at the schedule time of the to-do item, the user is reminded according to the to-do settings. When a reminder pop-up window for a certain application has already appeared, and a reminder pop-up window for a new application pops up within the countdown time for opening the application, the multiple pop-up windows can be displayed in a misaligned manner. Users can also edit and modify any schedule, and add new schedules.

In some embodiments, the embodiment performs the semantic recognition on the text recognition results through the following steps, and generates to-do items based on the semantic recognition results:
adding the text recognition result to the first editing area of the schedule editing interface; performing the semantic recognition on the text recognition result in the editing area, and adding the semantic recognition result to at least one second editing area; and generating to-do items according to the semantic recognition result in at least one second editing area.

In the implementation, as shown in FIGS. 31A and 31B, the embodiment provides a schematic diagram for adding a to-do item. After the user writes text, all the written text contents are specified through a hand-drawn rectangle, and text recognition is performed on the text content. As shown in FIG. 31A, the text recognition result is displayed in the first editing area of the schedule editing interface. The user can continue to edit the text recognition result, or can directly perform semantic recognition without editing, as shown in FIG. 31B. When the semantic recognition results include schedule subject, schedule content, schedule time, and schedule location, the schedule subject, schedule content, schedule time, and schedule location are respectively added to the corresponding second editing area for display. Users can also continue to edit the content displayed in the second editing area, or users can directly generate to-do items based on the content in each second editing area.

In some embodiments, after generating to-do items based on the semantic recognition results, the to-do items generated based on the semantic recognition results can also be added to a calendar program for display. The calendar program is displayed in form of window on the homepage of the desktop launcher.

In the implementation, users write text in the writing software, and specify the first text information of the relevant text by drawing the first trajectory information of the figure. The text recognition is performed on the first text information associated with the first trajectory information to obtain the text recognition results, the semantic recognition is performed on the text recognition results, and to-do items are generated based on the semantic recognition results. The text recognition results in the embodiment include text in standard fonts and/or standard formats, and the semantic recognition results include but are not limited to at least one of: subject, content, time, location, or preset keywords.

Optionally, after adding a to-do item, the user can also set a reminder time. For example, users can select 10 minutes, 15 minutes, 20 minutes, or 30 minutes before the schedule time of the to-do items to remind. As shown in FIG. 32, the embodiment provides a schematic diagram for reminding a to-do item. When a to-do item has an associated application, users can be prompted that the application is about to start, with a global pop-up window before the start of the schedule time of the to-do item, and other operations except in the pop-up window will be invalid. For example, a countdown reminder can be used. If the countdown is 0, the pop-up window is automatically closed and the relevant application is opened. When the user clicks “Open” in the prompt displayed in the pop-up window, the associated application is directly opened. When the user clicks “Cancel” in the prompt displayed in the pop-up window, the pop-up window disappears and the application does not start. When the user clicks “Got it” in the prompt displayed in the pop-up window, the pop-up window disappears, and the associated application is automatically opened when the scheduled schedule time comes.

Based on the same inventive concept, embodiments of the present disclosure further provide an interaction method based on figure recognition, as shown in FIG. 33. The specific process of implementing this method is as follows:
Step 3300: receiving trajectory information of multiple strokes hand-drawn by the user, where each stroke includes second trajectory information;
Step 3301: performing figure recognition on the second trajectory information of each stroke to obtain the recognition result of each stroke, and adding the recognition result of the strokes to the global recognition result list; where the first trajectory information is configured to trigger the execution of interactive instructions associated with associated text information;
Step 3302: if the recognition results in the global recognition result list match any type of preset rules in the preset rule set, emptying the global recognition result list and performing associated operations according to the interactive instructions corresponding to the global recognition result list.

Based on the same inventive concept, embodiments of the present disclosure further provide a display device. The principle of solving the problem of the display device is similar to any of the interaction methods based on figure recognition discussed above. Therefore, the implementation of the display device can be referred to the method, and the repetitive parts will be omitted.

As shown in FIG. 34, the display device includes a display 3400 and a controller 3401;
the display 3400 is configured to display content;
the controller 3401 is configured to perform the following steps:
receiving trajectory information of multiple figures hand-drawn by the user, where each figure includes first trajectory information;
performing figure recognition on the first trajectory information of each figure to obtain a recognition result of each figure, and adding the recognition result of each figure to a global recognition result list; and
If recognition results in the global recognition result list match the preset rules in the preset rule set, emptying the global recognition result list and performing an association operation according to interactive instructions corresponding to the global recognition result list.

As an optional implementation, the preset rules include multiple figure categories arranged in a preset order, and the controller 3401 is specifically configured to execute:
if the recognition result and recognition order of the current figure match the figure category and the arrangement order of the figure category in the preset rules respectively, then adding the recognition result of the current figure to the global recognition result list.

As an optional implementation, the preset rules include multiple figure categories arranged in a preset order, and the controller 3401 is specifically configured to perform following steps:
adding the recognition result of the current figure to the global recognition result list to obtain the current global recognition result list;
if the recognition results in the current global recognition result list do not match the figure categories in the preset rules, emptying the global recognition result list; or,
if the recognition results in the current global recognition result list match the figure categories in the preset rules, and the order of the recognition results in the current global recognition result list does not match the order of the figure categories, emptying the global recognition result list.

As an optional implementation, after adding the recognition result of each figure to the global recognition result list, the controller 3401 is specifically configured to perform following steps:
when the length of the global recognition result list reaches a threshold, determining whether the recognition results in the global recognition result list match the preset rules in the preset rule set.

As an optional implementation, the preset rules include figure categories arranged in a preset order, and the controller 3401 is specifically configured to perform following steps:
if the recognition result of the current figure does not match the figure category in the preset rules, emptying the global recognition result list; or,
if the recognition result of the current figure matches the figure category in the preset rule, and the recognition order of the recognition result does not match the order of the figure categories in the preset rule, emptying the global recognition result list.

As an optional implementation, the figure includes a first figure, and the first figure includes consecutive first stroke and second stroke; the controller 3401 is specifically configured to perform following steps:
receiving the trajectory information of the first stroke, recognizing the trajectory information of the first stroke, and if the recognition result matches the first stroke category, adding the recognition result of the first stroke to the global recognition result list;
receiving the trajectory information of the second stroke, combining the trajectory information of the first stroke and the trajectory information of the second stroke, performing figure recognition on the combined trajectory information, and adding the recognition result of the combined trajectory information to the global recognition result list.

As an optional implementation, after receiving the trajectory information of the first stroke, the controller 3401 is specifically configured to perform following steps:
determining the writing area of the trajectory information of the second stroke according to the trajectory information of the first stroke;
when the trajectory information of the second stroke is located in the writing area, combining the trajectory information of the first stroke and the trajectory information of the second stroke, and performing figure recognition on the combined trajectory information;
when the trajectory information of the second stroke is not within the writing area, emptying the global recognition result list.

As an optional implementation, the controller 3401 is specifically configured to performing following steps:
determining the center point of the writing area according to the center or center of gravity of the trajectory information of the first stroke and the last trajectory point of the trajectory information of the first stroke;
determining the writing area of the trajectory information of the second stroke according to the center point of the writing area.

As an optional implementation, the controller 3401 is specifically configured to perform following steps:
if it is determined that the global recognition result list is empty and the data volume of the first trajectory information of each figure is greater than the trajectory point threshold, performing figure recognition on the first trajectory information of each figure.

As an optional implementation, before performing figure recognition on the first trajectory information of each figure, the controller 3401 is specifically configured to perform following steps:
preprocessing the first trajectory information of each figure to remove noise in the first trajectory information, and converting the first trajectory information of the same figure with different specifications into unified standard data.

As an optional implementation, the controller 3401 is specifically configured to preprocess the first trajectory information of the figure in any one or more of the following ways:
removing identical trajectory points in the first trajectory information of the figure;
performing normalization processing on the first trajectory information of the figure to obtain normalized first trajectory information, where the normalization processing is configured to convert the first trajectory information of the figure into information of a fixed size;
performing resampling processing on the first trajectory information of the figure, where the resampling processing is configured to ensure that the data volume of the first trajectory information after the resampling processing of the figure is within a preset range; and
converting the first trajectory information of the figure into a data format required for figure recognition.

As an optional implementation, the controller 3401 is specifically configured to implement following steps:
if the ratio of the height and width of the figure is less than the threshold, updating the Y coordinate of the trajectory point included in the first trajectory information of the figure by using the height and width of the figure, and performing normalization processing on the updated first trajectory information according to the width of the figure; or,
if the ratio of the height and width of the figure is not less than the threshold, performing normalization processing on the first trajectory information of the figure according to the height of the figure.

As an optional implementation, the controller 3401 is specifically configured to perform following steps:
if the data volume of the normalized first trajectory information obtained after normalizing the first trajectory information of the figure is not equal to the trajectory point threshold, resampling the first trajectory information of the figure.

As an optional implementation, the controller 3401 is specifically configured to perform following steps:
use the new sampling density to sample the first trajectory information to obtain sampled data of the first trajectory information; where the new sampling density is obtained by updating the initial sampling density based on the trajectory point threshold and the total distance of the first trajectory information;
determining the number and position of trajectory points that need to be inserted between adjacent trajectory points according to the data volume of the sampled first trajectory information, the trajectory point threshold and the distance between adjacent trajectory points in the first trajectory information; and resampling the first trajectory information according to the number and position of trajectory points that need to be inserted between adjacent trajectory points.

As an optional implementation, the controller 3401 is specifically configured to perform following steps:
if multiple trajectory points need to be inserted between the adjacent trajectory points, after inserting one trajectory point, calculating the trajectory distance between the inserted trajectory point and the target trajectory point; where the target trajectory point is a trajectory point in the trajectory information after the inserted trajectory point and adjacent to the inserted trajectory point; and
determining the number and position of the trajectory points that need to be inserted between the inserted trajectory point and the target trajectory point according to the data volume of the first trajectory information after inserting the trajectory point, the trajectory point threshold and the trajectory distance.

As an optional implementation, after preprocessing the first trajectory information of the figure, the controller 3401 is specifically configured to perform following steps:
if the data volume of the first trajectory information of the preprocessed figure is not equal to the trajectory point threshold, deleting or inserting the trajectory point in the first trajectory information to ensure that the data volume of the first trajectory information is equal to the trajectory point threshold.

As an optional implementation, the controller 3401 is specifically configured to perform following steps:
determining the sampling method according to the number of strokes included in the figure corresponding to the first trajectory information;
using the sampling method to sample the first trajectory information to obtain the index value of the trajectory point that needs to be inserted or deleted; and
inserting a trajectory point based on the index value of an inserted trajectory point, or deleting a trajectory point based on the index value of a deleted trajectory point.

As an optional implementation, the controller 3401 is specifically configured to perform following steps:
if the number of strokes included in the figure corresponding to the first trajectory information is 1, randomly sampling the first trajectory information; and
if the number of strokes included in the figure corresponding to the first trajectory information is greater than 1, sampling each figure according to a sampling rate corresponding to each figure.

As an optional implementation, the controller 3401 is specifically configured to perform following steps:
converting the first trajectory information into a data format required for figure recognition according to the coordinates of the first trajectory information, the state of the writing medium corresponding to the first trajectory information, and whether the first trajectory information is a starting point.

As an optional implementation, the controller 3401 is specifically configured to perform following steps:
using a figure recognition model to perform figure recognition on the first trajectory information of the figure, where the figure recognition model includes a convolutional neural network and a recurrent neural network; and
inputting the first trajectory information of the figure into the convolutional neural network and the recurrent neural network respectively for feature extraction, obtaining the first feature output by the convolutional neural network and the second feature output by the recurrent neural network, and combining the first feature and the second feature to obtain a combined feature, and classify the combined feature to obtain a recognition result corresponding to the first trajectory information of the figure.

As an optional implementation, the recurrent neural network includes a two-layer network and a fully connected layer, the two-layer network includes a bidirectional long-short memory network and a Dropout layer;
the first trajectory information of the figure is input into the two-layer network and the fully connected layer in sequence, and the second feature is output.

As an optional implementation, the first trajectory information is configured to trigger execution of interactive instructions associated with associated text information, the controller 3401 is specifically configured to perform following steps:
according to the interactive instructions corresponding to the global recognition result list, performing an association operation on the displayed text.

As an optional implementation, the preset rules include two figure category sets arranged in a preset order, the two figure category sets include a first figure category set and a second figure category set, and the first figure category set includes a first figure category, and the second figure category set includes a second figure category;
the first figure category set or the second figure category set is configured to perform text selection operations.

As an optional implementation, the first figure category set is configured to perform text selection operations, and the second figure category set is configured to trigger the execution of interactive instructions.

As an optional implementation, the preset rules include a first figure category set and a second figure category set arranged in a preset order; or, a first figure category set and a first figure category set arranged in a preset order.

As an optional implementation, the controller 3401 is specifically configured to perform following steps:
determining a text based on the recognition results matching the first figure category in the global recognition result list, and determining interactive instructions based on the recognition results matching the second figure category in the global recognition result list; and
according to the interactive instructions, performing an association operation on the text.

As an optional implementation, the controller 3401 is specifically configured to perform following steps:
if the user draws multiple figures on the document display page, determining the content of the to-be-queried area based on the interactive instructions corresponding to the multiple figures, circling the content of the to-be-queried area, and performing the query operation; or,
if the user draws multiple figures on the display page of the writing software, invoking writing-related functions according to the interactive instructions corresponding to the multiple figures.

Based on the same inventive concept, embodiments of the present disclosure further provide a display device. The principle of solving the problem of the display device is similar to any of the interaction methods based on figure recognition discussed above. Therefore, the implementation of the display device can be referred to the method, the repetitive parts will be omitted.

As shown in FIG. 35, the display device includes a display 3500 and a controller 3501;
the display 3500 is configured to display content;
the controller 3501 is configured to perform the following steps:
receiving the first trajectory information of the user's hand-drawn figures; where the first trajectory information is configured to trigger the execution of interactive instructions associated with the first text information;
performing figure recognition on the first trajectory information and determining the figure recognition result; and
according to the interactive instruction corresponding to the figure recognition result, performing an association operation on the displayed first text information.

As an optional implementation, the first text information is determined based on the received handwriting information written by the user.

As an optional implementation, the controller 3501 is specifically configured to determine the first text information in the following manner:
receiving the handwriting information of the text written by the user, performing trajectory recognition on the handwriting information to determine the trajectory recognition result; replacing the handwriting information with the trajectory recognition result, and displaying the trajectory recognition result in a preset format, and determining displayed trajectory recognition result as the first text information; or,
receiving and displaying handwriting information of the text written by the user, and determining the displayed handwriting information as the first text information.

As an optional implementation, each figure includes multiple sub-figures, and the first trajectory information includes sub-trajectory information of multiple sub-figures; the controller 3501 is specifically configured to perform following steps:
receiving sub-trajectory information of multiple sub-figures hand-drawn by the user, performing figure recognition on the sub-trajectory information of the sub-figures, and obtaining first recognition results corresponding to the multiple sub-figures respectively; and
determining the figure recognition result according to multiple first recognition results.

As an optional implementation, the controller 3501 is specifically configured to perform following steps:
receiving the sub-trajectory information of multiple sub-figures in sequence according to the order of multiple sub-figures hand-drawn by the user; and
according to the receiving order of multiple sub-trajectory information, performing figure recognition on each sub-trajectory information in turn, and obtaining and saving a corresponding first recognition result.

As an optional implementation, the controller 3501 is specifically configured to performing following steps:
when the receiving order of the current sub-figure and the first recognition result corresponding to the sub-figure satisfy the preset interaction strategy, saving the first recognition result corresponding to the sub-figure.

As an optional implementation, after saving the first recognition result corresponding to the sub-figure, the controller 3501 is specifically configured to perform following steps:
when the current sub-figure is not the last sub-figure in the interaction strategy, determining the position range of the next sub-figure of the current sub-figure according to the interaction strategy; and
when the next sub-figure is not received within the position range, emptying the saved first recognition result corresponding to the current sub-figure.

As an optional implementation, after obtaining the first recognition results corresponding to the multiple sub-figures, the controller 3501 is specifically configured to determine to implement the interactive instructions corresponding to the figure recognition results in the following manner:
obtaining the recognition order of the first recognition results respectively corresponding to the multiple sub-figures, and when the recognition order satisfies the preset order, determining to implement the interactive instructions corresponding to the multiple first recognition results.

As an optional implementation, the sub-figure at least includes a first stroke and a second stroke; the controller 3501 is specifically configured to perform following steps:
recognizing the first stroke to obtain a first recognition result, and when the first recognition result is an incomplete figure, saving the first stroke;
according to the coordinate range of the missing second stroke, receiving the second stroke within the coordinate range, and recognizing the first stroke and the second stroke together to obtain a first recognition result.

As an optional implementation, each figure includes a first sub-figure and a second sub-figure; the first trajectory information includes the first sub-trajectory information of the first sub-figure and the second sub-trajectory information of the second sub-figure; the controller 3501 is specifically configured to implement the interactive instructions in the following manner:
receiving the first sub-trajectory information, performing figure recognition on the first sub-trajectory information, and obtaining the first recognition result of the first sub-figure; when the first recognition result of the first sub-figure is the first sub-figure, saving the first recognition result of the first sub-figure;
receiving the second sub-trajectory information, performing figure recognition on the second sub-trajectory information, and obtaining the first recognition result of the second sub-figure; when the first recognition result of the second sub-figure is the second sub-figure, implementing the interactive instructions corresponding to the first sub-figure and the second sub-figure.

As an optional implementation, each figure includes a first sub-figure and a second sub-figure.

The interactive instruction corresponding to the figure recognition result of the first sub-figure is configured to determine the range of the first text information associated with the interactive instruction.

The interactive instruction corresponding to the figure recognition result of the second sub-figure is configured to determine the interaction type, where different interaction types perform different association operations on the first text information.

As an optional implementation, the controller 3501 is specifically configured to perform following steps:
according to the interactive instructions corresponding to the figure recognition results, performing an alignment processing on each row of text and/or each column of text in the displayed first text information.

As an optional implementation, the controller 3501 is specifically configured to perform following steps:
determining first text information associated with the first trajectory information according to the relationship between the display positions of the first trajectory information and the first text information; and
according to the interactive instruction corresponding to the recognition result, performing an association operation on the first text information associated with the first trajectory information.

As an optional implementation, the first text information is handwriting information of text written by the user; the controller 3501 is specifically configured to perform the following steps:
according to the interactive instruction corresponding to the recognition result, replacing the first text information associated with the first trajectory information with a format corresponding to any one of a preset title, a preset subtitle, or a preset paragraph.

As an optional implementation, the controller 3501 is specifically configured to perform following steps:
according to the interactive instruction of the recognition result, performing text recognition on the first text information associated with the first trajectory information, and obtaining and displaying a text recognition result.

As an optional implementation, the controller 3501 is specifically configured to perform following steps:
according to the interactive instruction of the recognition result, performing semantic recognition on the first text information associated with the first trajectory information, and generating meeting minutes or to-do items according to the semantic recognition result.

As an optional implementation, the controller 3501 is specifically configured to perform following steps:
generating the meeting minutes based on at least one of the meeting title, meeting content, meeting time, or meeting location in the semantic recognition result.

As an optional implementation, the first text information includes meeting minutes; the meeting minutes include meeting time; the controller 3501 is specifically configured to:
receiving the first trajectory information associated with the meeting time, performing figure recognition on the first trajectory information, and determining the figure recognition result; and
according to the interactive instruction corresponding to the figure recognition result, starting a calendar program, and adding the meeting minutes to the calendar program as a to-do item.

As an optional implementation, the controller 3501 is specifically configured to perform following steps:
determining the application program associated with the to-do item according to the application program associated with at least one keyword in the semantic recognition result;
starting an application program associated with the to-do item at the schedule time of the to-do item.

As an optional implementation, the controller 3501 is specifically configured to perform following steps:
adding the text recognition result to the first editing area of the schedule editing interface;
performing semantic recognition on the text recognition results in the editing area, and adding the semantic recognition results to at least one second editing area; and
generating a to-do item based on the semantic recognition result in at least one second editing area.

As an optional implementation, after the to-do items are generated according to the semantic recognition result, the controller 3501 is specifically configured to perform following steps:
adding the to-do items generated based on the semantic recognition results to the calendar program for display;
the calendar program is displayed on the homepage of the desktop launcher in the form of a window.

Based on the same inventive concept, embodiments of the present disclosure further provide a display device. The principle of solving the problem of the display device is similar to any of the interaction methods based on figure recognition discussed above. Therefore, the implementation of the display device can be referred to the method, and the repetitive parts will be omitted.

As shown in FIG. 36, the display device includes a display 3600 and a controller 3601;
the display 3600 is configured to display content;
the controller 3601 is configured to perform the following steps:
receiving trajectory information of multiple strokes hand-drawn by the user, where each stroke includes second trajectory information;
performing figure recognition on the second trajectory information of each stroke to obtain the recognition result of each stroke, and adding the recognition result of the stroke to the global recognition result list; where the first trajectory information is configured to trigger execution of interactive instructions associated with associated text information; and
if the recognition results in the global recognition result list match any type of preset rules in the preset rule set, emptying the global recognition result list and performing an association operation according to the interactive instructions corresponding to the global recognition result list.

Based on the same inventive concept, embodiments of the present disclosure further provide a display device. The principle of solving the problem of the display device is similar to any of the interaction methods based on figure recognition discussed above. Therefore, the implementation of the display device can be referred to the method, and the repetitive parts will be omitted.

As shown in FIG. 37, the display device includes a display 3700 and a controller 3701;
the display 3700 is configured to display content;
the controller 3701 is configured to perform the following steps:
receiving the trajectory information of the figure drawn by the user;
performing figure recognition on the trajectory information to obtain the recognition result corresponding to the figure; and
invoking the writing function according to the interactive instruction corresponding to the recognition result, and displaying the menu items of the writing function in the writing area.

Based on the same inventive concept, embodiments of the present disclosure provide a computer storage medium. The computer storage medium includes: computer program code. When the computer program code is run on a computer, it causes the computer to perform any of the interaction methods based on figure recognition as discussed above. Since the problem-solving principle of the above computer storage medium is similar to the interaction method based on figure recognition, the implementation of the above computer storage medium can be referred to the implementation of the method, and repeated details will be omitted.

In a specific implementation process, the computer storage media may include: Universal Serial Bus Flash Drive (USB), mobile hard disk, Read-Only Memory (ROM), Random Access Memory (RAM), magnetic disks or optical disks and other storage media that can store the program code.

Based on the same inventive concept, embodiments of the present disclosure further provide a computer program product. The computer program product includes: computer program code. When the computer program code is run on a computer, it causes the computer to execute any interaction method based on figure recognition as discussed above. Since the problem-solving principle of the above-mentioned computer program product is similar to the interaction method based on figure recognition, the implementation of the above-mentioned computer program product can be referred to the implementation of the method, and repeated details will be omitted.

The computer program product may take any combination of one or more readable media. The readable medium may be a readable signal medium or a readable storage medium. The readable storage medium may be, for example, but not limited to, an electrical, magnetic, optical, electromagnetic, infrared, or semiconductor system, apparatus or device, or any combination thereof. More specific examples (non-exhaustive list) of readable storage media include: electrical connection with one or more conductors, portable disk, hard disk, random access memory (RAM), read only memory (ROM), erasable programmable read-only memory (EPROM or flash memory), optical fiber, portable compact disk read-only memory (CD-ROM), optical storage device, magnetic storage device, or any suitable combination of the above.

Those skilled in the art will appreciate that embodiments of the present disclosure may be provided as methods, systems, or computer program products. Accordingly, the present disclosure may take the form of an entirely hardware embodiment, an entirely software embodiment, or an embodiment that combines software and hardware aspects. Furthermore, the present disclosure may take the form of a computer program product implemented on one or more computer-usable storage media (including, but not limited to, magnetic disk storage and optical storage, etc.) embodying computer-usable program code therein.

The disclosure is described with reference to flowchart illustrations and/or block diagrams of methods, apparatus (systems), and computer program products according to embodiments of the disclosure. It will be understood that each process and/or block in the flowchart illustrations and/or block diagrams, and combinations of processes and/or blocks in the flowchart illustrations and/or block diagrams, can be implemented by computer program instructions. These computer program instructions may be provided to a controller 3501 of a general purpose computer, special purpose computer, embedded processor, or other programmable data processing device to produce a machine such that the instructions are executed by the controller 3501 of the computer or other programmable data processing device. An apparatus is produced for carrying out the functions specified in a process or processes of a flow diagram and/or a block or blocks of a block diagram.

These computer program instructions may also be stored in a computer-readable memory that causes a computer or other programmable data processing device to operate in a particular manner, such that the instructions stored in the computer-readable memory produce an article of manufacture including the instructed device. The instructed device implements the functions specified in a process or processes in the flow diagram and/or in a block or blocks in the block diagram.

These computer program instructions may also be loaded onto a computer or other programmable data processing device, causing a series of operating steps to be performed on the computer or other programmable device to produce computer-implemented processing, thereby executing on the computer or other programmable device. Instructions provide steps for implementing the functions specified in a process or processes of a flowchart diagram and/or a block or blocks of a block diagram.

Obviously, those skilled in the art can make various changes and modifications to the present disclosure without departing from the spirit and scope of the disclosure. In this way, if these modifications and variations of the present disclosure fall within the scope of the claims of the present disclosure and equivalent technologies, the present disclosure is also intended to include these modifications and variations.

1.-52. (canceled)

53. An interaction method based on figure recognition, comprising:
receiving first trajectory information of a figure hand-drawn by a user; wherein the first trajectory information is configured to trigger execution of interactive instructions associated with first text information;
performing figure recognition on the first trajectory information and determining a figure recognition result; and
performing an association operation on displayed first text information according to interactive instructions corresponding to the figure recognition result.

54. The method according to claim 53, wherein the first text information is determined according to received handwriting information written by the user.

55. The method according to claim 54, wherein the first text information is determined by:
receiving the handwriting information of a text written by the user, performing trajectory recognition on the handwriting information to determine a trajectory recognition result; replacing the handwriting information with the trajectory recognition result, and displaying the trajectory recognition result in a preset format, and determining the displayed trajectory recognition result as the first text information; or,
receiving and displaying the handwriting information of a text written by the user, and determining the displayed handwriting information as the first text information.

56. The method according to claim 53, wherein the figure comprises a plurality of sub-figures, and the first trajectory information comprises sub-trajectory information of the plurality of sub-figures;
the performing figure recognition on the first trajectory information and determining the figure recognition result, comprises:
receiving sub-trajectory information of a plurality of sub-figures hand-drawn by the user, performing figure recognition on the sub-trajectory information of the sub-figures to obtain first recognition results corresponding to the sub-figures respectively; and
determining the figure recognition result according to the first recognition results.

57. The method according to claim 56, wherein the performing figure recognition on the sub-trajectory information of the sub-figures to obtain the first recognition results corresponding to the sub-figures respectively, comprises:
receiving the sub-trajectory information of the sub-figures in sequence according to an order of the sub-figures hand-drawn by the user; and
performing figure recognition on each sub-trajectory information in sequence according to a receiving order of multiple sub-trajectory information to obtain the first recognition result, and saving the first recognition result.

58. The method according to claim 57, wherein the saving the first recognition result, comprises:
in response to a receiving order of a current sub-figure and the first recognition result corresponding to the current sub-figure satisfying a preset interaction strategy, saving the first recognition result corresponding to the current sub-figure.

59. The method according to claim 58, wherein after the saving the first recognition result corresponding to the current sub-figure, the method further comprises:
in response to the current sub-figure not being a last sub-figure in the preset interaction strategy, determining a position range of a next sub-figure of the current sub-figure according to the preset interaction strategy; and
in response to the next sub-figure not being received within the position range, emptying the saved first recognition result corresponding to the current sub-figure.

60. The method according to claim 56, wherein after obtaining the first recognition results respectively corresponding to the plurality of sub-figures, determining execution of the interactive instructions corresponding to the figure recognition results in the following manner:
obtaining a recognition order of the first recognition results respectively corresponding to the plurality of sub-figures, and in response to the recognition order satisfying a preset order, determining to execute the interactive instructions corresponding to the first recognition results.

61. The method according to claim 56, wherein each sub-figure comprises at least a first stroke and a second stroke;
the performing figure recognition on the sub-trajectory information of the sub-figures to obtain the first recognition results corresponding to the sub-figures respectively, comprises:
recognizing the first stroke to obtain the first recognition result, and in response to the first recognition result being an incomplete figure, saving the first stroke; and
according to a coordinate range of a missing second stroke, receiving the second stroke within the coordinate range, and recognizing the first stroke and the second stroke together to obtain the first recognition result.

62. The method according to claim 53, wherein each figure comprises a first sub-figure and a second sub-figure; the first trajectory information comprises a first sub-trajectory information of the first sub-figure and a second sub-trajectory information of the second sub-figure; and the execution of the interactive instructions comprises:
receiving the first sub-trajectory information, performing figure recognition on the first sub-trajectory information to obtain a first recognition result of the first sub-figure; in response to the first recognition result of the first sub-figure being the first sub-figure, saving the first recognition result of the first sub-figure; and
receiving the second sub-trajectory information, performing figure recognition on the second sub-trajectory information to obtain a first recognition result of the second sub-figure; in response to the first recognition result of the second sub-figure being the second sub-figure, executing the interactive instructions corresponding to the first sub-figure and the second sub-figure.

63. The method according to claim 53, wherein each figure comprises a first sub-figure and a second sub-figure;
interactive instructions corresponding to a figure recognition result of the first sub-figure are configured to determine a range of first text information associated with the interactive instructions; and
interactive instructions corresponding to a figure recognition result of the second sub-figure are configured to determine an interaction type, wherein different interaction types perform different association operations on the first text information.

64. The method according to claim 53, wherein the performing the association operation on the displayed first text information according to the interactive instructions corresponding to the figure recognition result, comprises:
aligning each row of text and/or each column of text in the displayed first text information according to the interactive instructions corresponding to the figure recognition result.

65. The method according to claim 53, wherein the performing the association operation on the displayed first text information according to the interactive instructions corresponding to the figure recognition result, comprises:
determining the first text information associated with the first trajectory information according to a relationship between a display position of the first trajectory information and a display position of the first text information; and
performing the association operation on the first text information associated with the first trajectory information according to the interactive instructions corresponding to the figure recognition result.

66. The method according to claim 65, wherein the first text information is handwriting information of a text written by the user;
the performing the association operation on the first text information associated with the first trajectory information according to the interactive instructions corresponding to the figure recognition result, comprises:
according to the interactive instructions corresponding to the figure recognition result, replacing the first text information associated with the first trajectory information with a format corresponding to any one of a preset title, a preset subtitle, or a preset paragraph.

67. The method according to claim 53, wherein the performing the association operation on the displayed first text information according to the interactive instructions corresponding to the figure recognition result, comprises:
according to the interactive instructions corresponding to the figure recognition result, performing text recognition on the first text information associated with the first trajectory information to obtain and display a text recognition result.

68. The method according to claim 53, wherein the first text information comprises meeting minutes; the meeting minutes comprises meeting time; the method further comprises:
receiving first trajectory information associated with the meeting time, performing figure recognition on the first trajectory information, and determining the figure recognition result; and
according to the interactive instructions corresponding to the figure recognition result, starting a calendar program, and adding the meeting minutes to the calendar program as a to-do item.

69. The method according to claim 53, wherein the generating to-do items according to a semantic recognition result, further comprises:
determining an application program associated with the to-do items according to an application program associated with at least one keyword in the semantic recognition result; and
starting the application program associated with the to-do items at a schedule time of the to-do items.

70. The method according to claim 53, wherein after generating to-do items according to the semantic recognition result, the method further comprises:
adding the to-do items generated according to the semantic recognition result to a calendar program for display;
wherein the calendar program is displayed on a homepage of a desktop launcher in a form of a window.

71. An interaction method based on figure recognition, comprising:
receiving trajectory information of a figure drawn by a user;
performing figure recognition on the trajectory information to obtain a recognition result corresponding to the figure; and
invoking a writing function according to interactive instructions corresponding to the recognition result, and displaying menu items of the writing function in a writing area.

72. A display device, comprising a display and a controller; wherein
the display is configured to display content; and
the controller is configured to perform:
receiving first trajectory information of a figure hand-drawn by a user; wherein the first trajectory information is configured to trigger execution of interactive instructions associated with first text information;
performing figure recognition on the first trajectory information and determining a figure recognition result; and
performing an association operation on displayed first text information according to interactive instructions corresponding to the figure recognition result.
